(19) United States
(12) Patent Application Publication
(10) Pub. No.: US 2026/0352621 A1
(43) Pub. Date: Nov. 5, 2026

(54) APPARATUS AND METHOD FOR RESOURCE-EFFICIENT MESSAGE DATA PROCESSING AND PREVIEW RENDERING IN A TERMINAL DEVICE

(71) Applicant: KAKAO CORP., Jeju-si (KR)

(72) Inventors: NA YEON KIM, Yongin-si (KR); JISOO YOUK, Seongnam-si (KR); JIN YEONG KIM, Seongnam-si (KR); CHANG YONG LEE, Yongin-si (KR)

(73) Assignee: KAKAO CORP., Jeju-si (KR)

(21) Appl. No.: 19/665,392

(22) Filed: May 1, 2026

(30) Foreign Application Priority Data
May 2, 2025 (KR) 10-2025-0058459

(51) Int. Cl. H04L 51/216; G06F 3/0485; H04L 51/04; H04L 51/224

(52) U.S. Cl. CPC H04L 51/216; G06F 3/0485; H04L 51/04; H04L 51/224

(57) ABSTRACT

A method and apparatus for an instant messaging service are provided. The method includes obtaining, from among first instant messages loaded on a terminal and corresponding to a chatroom in which an account of a user participates, second instant messages corresponding to a predefined condition, generating a first element corresponding to the chatroom, generating interfacing objects configured to display a preview of at least a portion of the second instant messages, based on types corresponding to the second instant messages, generating a second element including the interfacing objects, based on a first criterion according to a receipt time of an instant message and second criteria corresponding to the types, and displaying a list view including the first element and the second element.

### CROSS-REFERENCE TO RELATED APPLICATION

This application claims the benefit of Korean Patent Application No. 10-2025-0058459, filed on May 2, 2025, in the Korean Intellectual Property Office (now the Ministry of Intellectual Property (MOIP)), the entire disclosure of which is incorporated herein by reference for all purposes.

### BACKGROUND

### Technical Field

One or more embodiments relate to a method and apparatus for an instant messaging service.

### DESCRIPTION OF THE RELATED ART

Conventional terminal interfaces for instant messaging are constrained by limited display area, and typically employ hierarchical navigation structures in which multimedia content is accessed through individual chatroom interfaces. As a result, when a user attempts to access specific content, such as images, videos, or link information, the terminal generally performs a sequence of processing operations including loading message histories associated with a selected chatroom, initializing a corresponding user interface, and rendering message content within that interface. These operations may involve retrieval of data from local memory and, in some cases, synchronization with a remote server, thereby increasing processing overhead and latency associated with accessing the content.

In systems that support multiple concurrent chatrooms, users often navigate across different chatroom interfaces to locate desired content. This process may result in repeated loading and rendering of message data that is not directly relevant to the user’s immediate objective. For example, in order to identify a particular multimedia element, the terminal may load and process a set of messages within a chatroom, even though only a subset of those messages contains relevant content. Such repeated operations may increase utilization of processing resources, memory allocation, and network bandwidth, particularly when transitions between chatroom interfaces occur frequently.

Additionally, conventional messaging interfaces generally present chatroom lists and message content using a single navigation axis, such as vertical scrolling, without providing mechanisms for separately managing different categories of data. As a result, message content of different types, including text, multimedia, and link information, is typically accessed through the same interaction model, which may not account for differences in data size, rendering requirements, or user intent. This unified approach may lead to inefficient rendering operations, including repeated decoding of media content and redundant display of similar data across multiple chatrooms.

Accordingly, there exists a need for improved techniques for managing and presenting message data in a terminal that reduce unnecessary data retrieval and rendering operations, while enabling efficient access to relevant content across multiple chatrooms. In particular, there is a need for an interface architecture that supports selective processing of message data and more efficient interaction patterns that reduce computational overhead associated with accessing multimedia content in an instant messaging environment.

### BRIEF SUMMARY

The present disclosure describes a messaging interface that supplements a conventional chatroom list with an additional preview layer. From a larger set of messages, a subset is selected based on combined conditions such as recency, content type, and visibility constraints, including exclusion of deleted or hidden messages. These selected messages are presented as interfacing objects within a horizontally scrollable second element, while the chatroom list remains vertically scrollable. This arrangement enables separate yet coordinated navigation of conversations and message content within a single display.

The system applies multiple criteria to determine the order and presentation of the preview objects. Messages may be prioritized based on receipt time, content type, and contextual considerations such as reducing repetition or adjusting for content that may expire. Each interfacing object is configured to display preview data according to the type of content, including images, video, link information, or files. In response to user input, a preview interface may be displayed that presents the selected message together with nearby messages in time, allowing contextual review before optionally navigating to the associated chatroom at a position corresponding to the message.

The interface also supports adaptive behavior based on user interaction and system conditions. For example, preview objects may be reordered in response to user selections, and preview displays may transition automatically or in response to gesture inputs. Scroll states may be maintained or reset according to predefined conditions. In addition, summary data may be generated for unread messages within a chatroom and presented as a separate interfacing object alongside other previews. This configuration enables presentation of both individual message previews and summarized conversation content within a unified interface.

For example, various embodiments provide a method of operating a terminal using an instant messaging service, the method including obtaining, from among first instant messages loaded on the terminal and corresponding to a chatroom in which an account of a user participates, second instant messages corresponding to a predefined condition, generating a first element corresponding to the chatroom, generating interfacing objects configured to display a preview of at least a portion of the second instant messages, based on types corresponding to the second instant messages, generating a second element including the interfacing objects, based on a first criterion according to a receipt time of an instant message and second criteria corresponding to the types, and displaying a list view including the first element and the second element.

The method may further include generating the list view by disposing the second element above the first element.

The first element and the second element may be scrollable in a first direction within the list view, and the interfacing objects may be scrollable in a second direction, which is different from the first direction, within the second element.

The generating of the second element may include sorting the second instant messages according to the first criterion, sorting the second instant messages based on the types and the second criteria, and generating the second element in which the interfacing objects are arranged based on a sorting order of corresponding second instant messages.

The second criteria may include a criterion for differentiating sorting among second instant messages having a common attribute.

The method may further include receiving, from the user, a first input corresponding to one of the interfacing objects, and in response to receiving the first input, sorting the interfacing objects on the second element such that remaining interfacing objects are arranged with higher priority than the one interfacing object.

The method may further include receiving, from the user, a first input corresponding to one of the interfacing objects and displaying a chatroom including a second instant message corresponding to the one interfacing object.

The displaying of the chatroom may include, in response to receiving the first input, displaying a first interface including a preview of the corresponding second instant message and a second interfacing object for navigating to the chatroom, and in response to receiving, from the user, a second input corresponding to the second interfacing object, displaying the chatroom.

The method may further include, in response to receiving the first input, obtaining, from among the first instant messages, at least one third instant message received within a predefined time range from a receipt time of the corresponding second instant message in the chatroom, and displaying the at least one third instant message on the first interface.

The displaying of the chatroom may include determining, based on log data of the corresponding second instant message, a location of the corresponding second instant message within the chatroom, and displaying the chatroom based on the location such that the corresponding second instant message is displayed.

The first interface may be displayed on the terminal for a third predefined time, and in response to expiration of the third predefined time, the first interface may transition to a second interface configured to display a preview corresponding to an interfacing object arranged after the one interfacing object within the second element.

In response to a swipe input from the user, the first interface may transition to a second interface configured to display a preview corresponding to an interfacing object arranged before or after the one interfacing object within the second element.

Each of the interfacing objects may display a combination of at least one of information of a chatroom including a corresponding second instant message, sender information of the corresponding second instant message, preview data based on the types, and receipt time information of the corresponding second instant message.

The method may further include obtaining, from among the first instant messages, a plurality of unread instant messages corresponding to the chatroom, and the generating of the interfacing objects may include generating, for a chatroom including at least a portion of the plurality of unread instant messages, at least one third interfacing object configured to display summary data of at least a portion of the plurality of unread instant messages.

The method may further include receiving, from the user, a third input corresponding to one of the at least one third interfacing object included in the second element, in response to the third input, obtaining summary data corresponding to at least a portion of the plurality of unread instant messages, and displaying a third interface configured to display the summary data.

In response to an input from the user, the third interface may transition to a fourth interface configured to display a preview corresponding to a third interfacing object arranged before or after the one third interfacing object within the second element.

The obtaining of the second instant messages may include obtaining the second instant messages by excluding, from among the first instant messages, an instant message corresponding to at least one of an instant message that is deleted or an instant message included in a hidden chatroom.

The obtaining of the second instant messages may include obtaining the second instant messages in response to at least one of an access to a first tab configured to display the list view within the instant messaging service, the access to the first tab according to a transition to a foreground during background execution of the instant messaging service, a transition to the first tab during access to a second tab within the instant messaging service, the access to the first tab according to receiving an input of a back button while a second screen, which is different from a first screen displaying the first tab, is displayed and not receiving a second new instant message within a predefined time after receiving a first new instant message while the first screen is displayed.

Embodiments provide a terminal for performing an instant messaging service, the terminal including a display, a communication interface, a memory, and at least one processor coupled to the memory, in which the memory stores instructions that, when executed individually or collectively by the at least one processor, cause the terminal to obtain, from among first instant messages loaded on the terminal and corresponding to a chatroom in which an account of a user participates, second instant messages corresponding to a predefined condition, generate a first element corresponding to the chatroom, generate interfacing objects configured to display a preview of at least a portion of the second instant messages, based on types corresponding to the second instant messages, generate a second element including the interfacing objects, based on a first criterion according to a receipt time of an instant message and second criteria corresponding to the types, and display a list view including the first element and the second element.

Additionally, embodiments described herein provide methods and apparatuses for improving operation of a terminal device by reducing processing and rendering overhead associated with accessing message content across multiple chatrooms. In particular, a subset of messages is selectively obtained from a larger set of messages based on predefined conditions including temporal criteria, content type, and visibility constraints. By limiting the volume of message data subject to further processing, the disclosed techniques reduce memory usage and computational load associated with rendering message content.

The selected messages are used to generate preview data corresponding to the messages, where the preview data comprises reduced representations of message content. The preview data may be generated based on content type, such that different data transformation processes are applied for images, video, link information, and files. The preview data is displayed within a user interface that includes a first region corresponding to chatroom elements and a second region corresponding to preview elements, where the first region is scrollable in a first direction and the second region is scrollable in a different direction. This interface structure enables independent navigation of chatroom data and message content without requiring loading of full chatroom data for each interaction.

In response to user input, the terminal device may provide a preview interface that displays preview data together with a limited set of temporally adjacent messages, thereby enabling contextual access to message content without rendering an entire chatroom. Navigation to a chatroom may be performed based on identifying a location of a corresponding message using associated metadata, thereby reducing additional search and rendering operations. In addition, ordering of preview elements may be determined based on multiple criteria including receipt time and content type, and may be dynamically updated based on user interaction. Through these operations, the disclosed techniques reduce data retrieval from a server, limit client-side rendering operations, and improve efficiency of memory and processor utilization in the terminal device.

### BRIEF DESCRIPTION OF THE SEVERAL VIEWS OF THE DRAWINGS

FIG. 1 is a diagram illustrating an overview of a system for providing an instant messaging service, according to an embodiment.

FIG. 2 is a flowchart illustrating a method of operating a terminal using an instant messaging service, according to an embodiment.

FIG. 3 is a diagram illustrating a list view, according to an embodiment.

FIG. 4 is a diagram illustrating an interfacing object included in a second element, according to an embodiment.

FIGS. 5A and 5B are diagrams illustrating interfacing objects displayed within a second element, according to an embodiment.

FIG. 6 is a flowchart illustrating a method of navigating to a chatroom in response to selection of an interfacing object, according to an embodiment.

FIGS. 7A and 7B are diagrams illustrating a method of displaying a chatroom, according to an embodiment.

FIGS. 8A and 8B are diagrams illustrating a method of providing a first interface, according to an embodiment.

FIG. 9 is a diagram illustrating a method of providing a first interface in response to deletion of an instant message, according to an embodiment.

FIG. 10A is a flowchart illustrating a method of generating an interfacing object for providing summary data, according to an embodiment.

FIG. 10B is a flowchart illustrating a method of generating summary data, according to an embodiment.

FIGS. 11A and 11B are diagrams illustrating a method of providing summary data, according to an embodiment.

FIG. 12 is a diagram illustrating a hardware configuration of a system for providing an instant messaging service, according to an embodiment.

### DETAILED DESCRIPTION

The following structural or functional descriptions of examples are provided as examples only, and various alterations and modifications may be made to the examples. Accordingly, the embodiments are not to be construed as limited to the disclosure and should be understood to include all changes, equivalents, or replacements within the idea and the technical scope of the disclosure.

With regard to the description of the drawings, similar reference numerals may be used to refer to similar or related elements. It is to be understood that a singular form of a noun corresponding to an item may include one or more of the things, unless the relevant context clearly indicates otherwise.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

Terms, such as “first” or “second”, are simply used to distinguish a component from another component and do not limit the components in other aspects (e.g., importance or sequence). For example, a first component may be referred to as a second component, or similarly, the second component may be referred to as the first component within the scope of the present disclosure.

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

The singular forms “a”, “an”, and “the” are intended to include the plural forms as well, unless the context clearly indicates otherwise. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Conventional instant messaging systems typically require sequential access to individual chatrooms in order to identify relevant content, which results in repeated data retrieval and rendering operations across large message datasets. Such approaches often involve loading entire chat histories or substantial portions thereof, even when only a small subset of messages is of interest. This leads to inefficient use of device resources, including increased memory allocation, higher processing demands on central and graphical processing units, and unnecessary network communication. In addition, conventional interfaces rely on a single scrolling paradigm and do not effectively differentiate between message content types or relative importance, which further contributes to redundant rendering of low priority or repetitive content and increased latency in accessing relevant information.

The disclosed system addresses these technical limitations through coordinated operations involving selective data extraction, structured interface configuration, and controlled interaction processing. In particular, a subset of messages is identified from a larger set of messages based on predefined conditions including temporal criteria, content type, and exclusion of non relevant data such as deleted messages or messages associated with hidden chatrooms. By reducing the volume of data prior to rendering, the system limits memory usage and processing overhead. The selected messages are then used to generate preview data in reduced representations, such as thumbnails or metadata based summaries, thereby avoiding retrieval and decoding of full content unless required.

The interface is configured to include a first region corresponding to chatroom elements and a second region corresponding to preview elements, where the first region is scrollable in a first direction and the second region is scrollable in a different direction. This arrangement enables independent navigation of chatroom structures and message content without requiring repeated loading of chatroom data. The system further applies multiple prioritization criteria, including message receipt time and content type, to determine an ordering of preview elements, while suppressing redundant or repetitive content. In addition, preview generation is performed in a type dependent manner, such that different data representations are generated for images, video, link information, and files, thereby reducing processing requirements associated with rendering heterogeneous content.

In response to user interaction, the system may provide an intermediate interface that displays preview data together with a limited set of temporally adjacent messages, enabling contextual review without loading an entire chatroom. Navigation to a chatroom may then be performed based on identifying a location of a corresponding message using associated metadata, thereby avoiding additional search operations within the chatroom. The system may also dynamically update ordering of preview elements based on user input and maintain interface state information across transitions to reduce re rendering operations. In addition, generation of summary data for unread messages may be deferred until a corresponding user input is received, thereby controlling invocation of computationally intensive processing and reducing unnecessary use of processing and network resources.

Through these coordinated mechanisms, the system reduces the amount of data retrieved from a server, limits client side rendering operations, and decreases memory consumption associated with processing large message sets. The system further reduces the number of interface transitions that require loading of full chatroom content and improves responsiveness in accessing relevant messages. By structuring interaction and data processing in this manner, the disclosed techniques provide improvements in the operation of computing devices used to implement messaging services, including more efficient use of processing, memory, and network resources.

Hereinafter, examples are described in detail with reference to the accompanying drawings. When describing the embodiments with reference to the accompanying drawings, like reference numerals refer to like elements, and a repeated description related thereto is omitted.

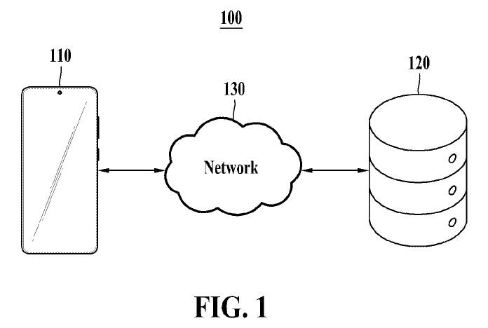

FIG. 1 is a diagram illustrating an overview of a system for providing an instant messaging service, according to an embodiment.

Referring to FIG. 1, a system 100 for providing an instant messaging service, according to an embodiment, may include a terminal 110, a server 120, and a network 130. Detailed hardware configurations of the server 120 and the terminal 110 are described below.

The server 120 may be a server associated with an instant messaging service. The server 120 may include a server for providing an instant messaging service through the network 130. In an example, the server 120 may be implemented as a module within an instant messaging server. In an example, the server 120 may include a separate server associated with the server for providing an instant messaging service through the network 130. When associated with the instant messaging server, the server 120 may be connected to or may communicate with the instant messaging server through the network 130. The instant messaging service may include a service that enables a plurality of users to perform real-time chats by transmitting instant messages, such as text messages, voice messages, and media files, through the network 130, such as a wireless Internet or a wireless communication network, and may further include services associated therewith.

The instant messaging service may enable the plurality of users to transmit and receive various types of content, and the various types of content may be classified into content corresponding to a notification area, a chat area, a channel area, and a vertical service area. The types of content described below are provided as examples and are not necessarily limited thereto. The notification area may include AI-based conversation summaries, reactions, replies, and mentions, and the chat area may include general messages, media (e.g., photos, videos, files, links, or emoticons), schedule or event information, and bulletin board content (e.g., announcements or polls). In the channel area, advertising messages, informational messages, and coupons may be transmitted and received, and in the vertical service area, various specialized functions, such as money transfer, location sharing, gift transmission, live messages, and scheduled messages, may be supported.

The server 120 may be associated with a web for the instant messaging service or an application (hereinafter, the app) for the instant messaging service executed by the terminal 110 to provide a user interface (UI), a function, an operation, or a service. Hereinafter, the web for the instant messaging service or the app for the instant messaging service may be referred to as an instant messenger.

The terminal 110 may be one of electronic devices, such as a computer, a portable computer, a wireless phone, a mobile phone, a smartphone, a personalized digital assistant (PDA), a web tablet, and a wearable device, and may refer to any device that may install and execute an app or may execute a web. In this case, the terminal 110 may be provided with services and/or content through an app or a web. For example, by control of an app or a web, the terminal 110 may perform overall service operations, such as service screen setting, data input, data transmission and reception, and data storage. For example, the terminal 110 may process a UI or user interaction through a processor and may output a processing result through an output device of the terminal 110 or transmit the processing result.

The terminal 110 may execute an instant messenger provided by the server 120. A user may use the instant messaging service provided by the server 120 by executing the instant messenger in the terminal 110. The user may generate a user account by subscribing to the instant messaging service through the instant messenger. The user may use the instant messaging service through the terminal 110 of an account subscribing to the instant messaging service. The terminal 110 of the account subscribing to the instant messaging service may be a terminal logging in with the account subscribing to the instant messaging service.

According to an embodiment, a chat interface may be provided to the terminal 110 through the app for the instant messaging service. The chat interface may be an interface for a message transmission/reception function associated with the instant messaging service and may include, for example, an interface that provides a function of transmitting messages through a chatroom, in which at least one user account participates, and displays received messages. The chat interface may correspond to a chatroom, which is a virtual space in which at least one user account participates and a chat among participants takes place. The chatroom may be, for example, one of a chatroom in which a single account participates, a one-to-one chat room in which two participants communicate with each other, or a group chatroom in which three or more participants communicate as a group.

The terminal 110 may share messages and other information exchanged among participants through interfacing objects (e.g., speech bubbles or templates different from the speech bubbles) displayed in the chatroom. In this case, text-based conversations may be transmitted between the user and their counterpart through the chatroom, and various types of data, including voice messages, media files, and link information, such as URLs, may also be shared. The link information may be shared through a chat window by the user entering a URL into a message input field, the user requesting sharing of the link information from another medium (e.g., another chatroom, an app, or a web page), or the counterpart transmitting the link information to the user. The link information may include, for example, an address (e.g., a URL) that links to a web page or an app page accessible through the network 130.

The terminal 110 may execute a series of instructions to provide a preview corresponding to an instant message. For example, the server 120 may generate an interfacing object for providing a preview of an instant message received through a chatroom. Detailed operations of the terminal 110 will be described below.

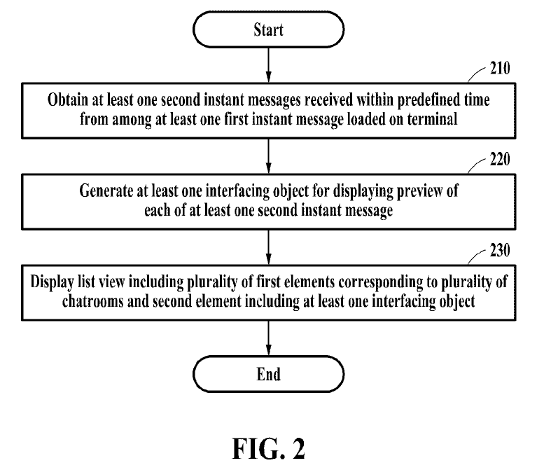

FIG. 2 is a flowchart illustrating a method of operating a terminal using an instant messaging service, according to an embodiment.

According to an embodiment, the terminal using the instant messaging service may correspond to the terminal 110 of FIG. 1. Hereinafter, the “terminal using the instant messaging service” may be briefly referred to as the “terminal”. In addition, a “first instant message”, a “second instant message”, or a “third instant message” may each be referred to as an “instant message”.

According to an embodiment, upon accessing the instant messaging service, the terminal 110 may receive, from the server 120, a list of chatrooms in which an account of the terminal 110 is currently participating. For each of the chatrooms included in the received list, the terminal 110 may receive, from the server 120, and load instant messages transmitted and received after instant messages previously loaded on the terminal 110 during a previous access. In addition, the terminal 110 may receive, from the server 120, and load instant messages transmitted and received in real time during access to the instant messaging service, in addition to at a time of access.

Instant messages may be classified into read messages and unread messages based on whether a chatroom has been viewed. The read messages may correspond to messages that are marked as read collectively or individually as a user of the terminal 110 views the chatroom. The unread messages may correspond to messages that are received by the terminal 110 but are marked as unread because the user has not viewed the chatroom.

In an instant messaging service, various types of content may be transmitted and received between a plurality of terminals through instant messages. For example, the content transmitted and received through the instant messages may include visual media, such as images and videos, and multimedia, such as document files, text, voice files, location information, contact information, schedule information, link information (e.g., a URL), or a combination thereof. The images transmitted and received through the instant messages may include a single image or a bundled image including a plurality of images.

When an instant message includes visual media (e.g., images, bundled images, videos, and bundled content including both images and videos), the terminal 110 may process display of the visual media based on whether the visual media has been downloaded. For example, the terminal 110 may first receive thumbnail data corresponding to the visual media from the server 120 and may display the visual media of the instant message on the terminal 110 based on the received thumbnail data. The thumbnail data may correspond to compressed data of original data, generated to enable rapid identification and management of the content of the original data. Thereafter, when the user views the chatroom, the terminal 110 may automatically download visual media from the server 120 or may download the visual media upon receiving a download input from the user corresponding to the visual media. The downloaded visual media may include an original file. Thereafter, the instant message including the visual media may be displayed using the downloaded visual media.

In addition, when an instant message includes visual media, the terminal 110 may process the visual media differently depending on whether the user subscribes to a storage service (e.g., a cloud-based storage service). According to an embodiment, the storage service may include a service for collectively managing data transmitted and received in at least one chatroom in which the user of the instant messaging service is participating. For example, the storage service may automatically back up conversation content and media files on the terminal 110 to enable access thereto at any time without data loss, and the backed-up data may be managed by automatically optimizing storage space of the terminal 110. In addition, the storage service may organize files on a per-folder basis to enable more convenient navigation by the user and may be configured to allow access to the system without inconvenience in various environments and while moving. The storage service may securely protect the backed-up data through encryption and security mechanisms and may enable rapid retrieval and use of the stored data as needed.

For data managed through the storage service, a management policy including a storage period and/or a storage location may vary depending on the types of data and/or the types of users (e.g., paid users or free users). For example, for paid users, a storage period of data may be unlimited, whereas for free users, the storage period of data may be limited to a predefined period (e.g., one month or one year). Access to some services provided by the instant messaging service may be restricted depending on the management policy of the storage service.

For example, when the user of the terminal 110 subscribes to the storage service, the terminal 110 may receive original data of visual content from a server providing the storage service and may use the received original data to display visual media included in an instant message. In contrast, when the user of the terminal 110 does not subscribe to the storage service, the terminal 110 may display visual content of an instant message using original data downloaded upon viewing a chatroom or upon receiving a separate download input after viewing the chatroom.

Referring to FIG. 2, a method of operating a terminal using an instant messaging service, according to an embodiment, may include operation 210 of obtaining second instant messages corresponding to a predefined condition from among first instant messages loaded on the terminal for chatroom(s) in which an account of the terminal is participating.

The first instant messages may correspond to instant messages loaded on the terminal 110 based on a specific time (e.g., a current time or a time of access) at which the instant messaging service is used. For example, the first instant messages may include messages received from the server 120 and loaded at a time of access to the instant messaging service, messages received from the server 120 and loaded in real time during access, messages received from the server 120 and loaded during a period from a previous access to the instant messaging service to a termination of the previous access, or a combination thereof.

The second instant messages may correspond to messages that satisfy a predefined condition from among the first instant messages. The predefined condition may include at least one time condition associated with a message, a condition based on the type of a message, or a combination thereof. According to an embodiment, the second instant messages may be messages received within a predefined time from a time at which the second instant messages are to be obtained. The predefined time may be set by the server 120 or directly by the user of the terminal 110. For example, when the predefined time is set to 24 hours, the second instant messages may correspond to instant messages received within 24 hours from the current time of access.

In addition, according to an embodiment, the second instant messages may include messages corresponding to a predefined type from among the first instant messages. An instant message corresponding to the predefined type may be an instant message, among the second instant messages, that includes content of at least one predefined type. According to an embodiment, the at least one predefined type may be set by the server 120 and/or the terminal 110. The predefined type may be received from the server 120 by the terminal 110 or may be determined by the user of the terminal 110.

For example, among various types, such as general messages (e.g., text), media (e.g., photos, videos, files, links, or emoticons), schedule or event information, and bulletin board content (e.g., notices or polls), messages corresponding to some types set by the server 120 and/or the terminal 110 may be obtained as the second instant messages. Alternatively, the predefined type may vary depending on an environment in which the instant messaging service is performed. The environment in which the instant messaging service is performed may include a type of the user’s terminal device (e.g., a smartphone, a tablet, or a desktop), an operating system (OS), version information of an installed app, a screen size, a network state, user account setting information, or a combination thereof. For example, when the terminal 110 is a device that does not support a voice file, the predefined type may be set to content types (e.g., an image type, a bundled image type, or a video type) excluding the voice file.

The second instant messages may be obtained in response to access to the instant messaging service. In addition, the second instant messages may be newly obtained in response to access to a first tab for displaying a list view during operation of the instant messaging service, the first tab (hereinafter referred to as a “chat tab”). The instant messaging service may provide a plurality of tabs for performing specific functions. The plurality of tabs may include tabs forming a navigation bar that enables the user of the terminal 110 to navigate to a screen corresponding to a tab associated with a specific function within an app.

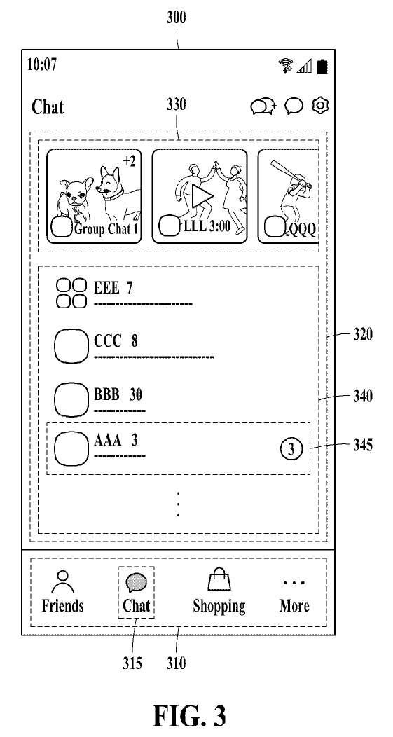

For example, the instant messaging service may include a friends list tab, a chat tab, a shopping tab, a settings tab, or a combination thereof. The chat tab may include a general chat list tab or an anonymous chat list tab. Referring to FIG. 3, a navigation bar 310 provided in an instant messaging service according to an embodiment is illustrated. The navigation bar 310 may include a friends list tab, a chat tab 315, an open chat tab, a shopping tab, and a settings tab. The terminal 110 may obtain second instant messages upon receiving a user input corresponding to the chat tab 315 of the navigation bar 310.

In addition, the terminal 110 may obtain the second instant messages in response to access to the chat tab 315 upon transitioning to a foreground during background execution of the instant messaging service. The terminal 110 may obtain the second instant messages in response to a transition to a first tab during access to a second tab within the instant messaging service, that is, in response to a user accessing the chat tab 315 from a tab other than the chat tab 315 within the instant messaging service. The terminal 110 may obtain the second instant messages in response to the user re-accessing the chat tab 315 via an input of a back button while a screen other than a chat tab screen is being displayed. When the terminal 110 receives a first new instant message while the chat tab 315 is displayed, and when an additional second new instant message is not received within a predefined time, the terminal 110 may obtain the first new instant message as a second instant message.

The second instant messages may include instant messages obtained by excluding, from among the first instant messages, instant messages corresponding to instant messages that are deleted, instant messages included in a hidden chatroom, or a combination thereof.

A deleted instant message may correspond to an instant message for which a deletion flag is set according to a user setting of the terminal 110, such that the instant message is no longer displayed or processed by the terminal 110 or the server 120. The deleted instant message may include an instant message processed such that the instant message is not displayed only on the terminal 110, or an instant message processed such that the instant message is not displayed on other terminals, including the terminal 110, that received the instant message before deletion.

The hidden chatroom may correspond to a chatroom for which a hiding flag is set according to the user setting of the terminal 110, such that the chatroom is not displayed in a chatroom list tab. The terminal 110 may obtain the second instant messages by excluding instant messages for which a deletion flag is set and instant messages transmitted or received in a chatroom for which a hiding flag is set.

The method of operating a terminal using an instant messaging service, according to an embodiment, may include operation 220 of generating at least one interfacing object configured to display a preview of at least a portion of the second instant messages, based on types corresponding to the second instant messages.

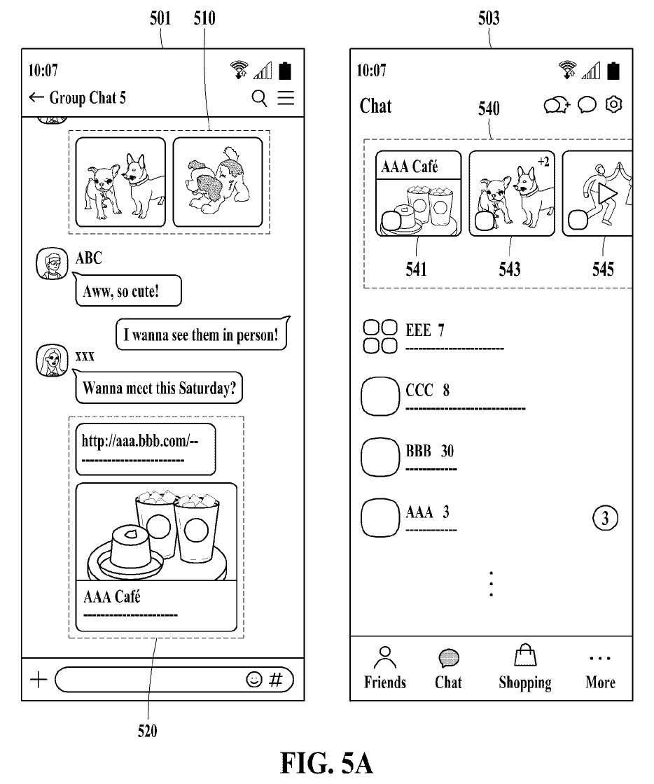

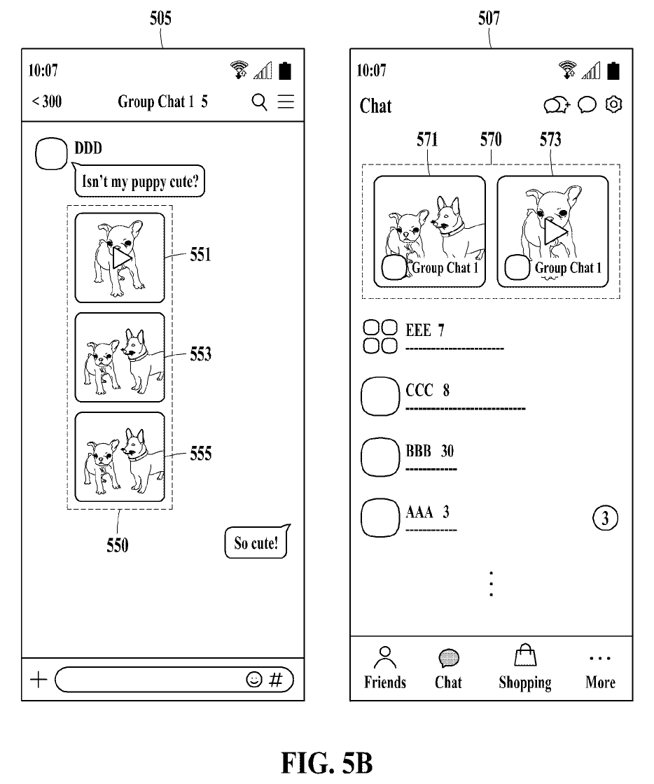

The terminal 110 may generate an interfacing object corresponding to at least a portion of the second instant messages. As described above, at least one of the second instant messages may be determined based on at least one type corresponding to the second instant messages or receipt time information. The at least one second instant message will be described in more detail below with reference to FIGS. 5A and 5B.

The at least one type corresponding to the second instant messages may include a type of content included in each of the second instant messages.

The terminal 110 may generate an interfacing object configured to display a preview of at least a portion of the second instant messages. The interfacing object for displaying the preview may be configured to display a combination of at least one of chatroom information including a corresponding second instant message, sender information of the corresponding second instant message, receipt time information of the corresponding second instant message, and preview data based on the at least one type.

The chatroom information may include chatroom name information, chatroom type information (e.g., a 1:1 chat or a group chat), chatroom profile information, or a combination thereof. The sender information may include a sender name, sender profile information, a sender account type (e.g., a corporate account or a personal account), or a combination thereof. The receipt time information may include a time at which an instant message was transmitted from a transmitting terminal to the server 120 or a time at which the instant message was received by the terminal 110. The terminal 110 may display the receipt time information on the interfacing object or may display a time difference between a current time and a time corresponding to the receipt time information (e.g., “2 hours ago”).

The preview may correspond to a view that enables a user to identify content included in a second instant message without opening a chatroom including the second instant message. The preview data may correspond to data used to display the preview. The preview data may include data of an image, a video, or a GIF image type.

The preview data may be determined based on at least one type corresponding to the second instant messages. The preview data may be determined based on visual media when a corresponding instant message is an instant message including visual media (e.g., images, bundled images, videos, or link images). In addition, the preview data may be determined based on an image or text for visually representing multimedia, or a combination thereof, when the corresponding instant message is an instant message including multimedia (e.g., document files, text, voice files, location information, contact information, schedule information, or link information (e.g., a URL)).

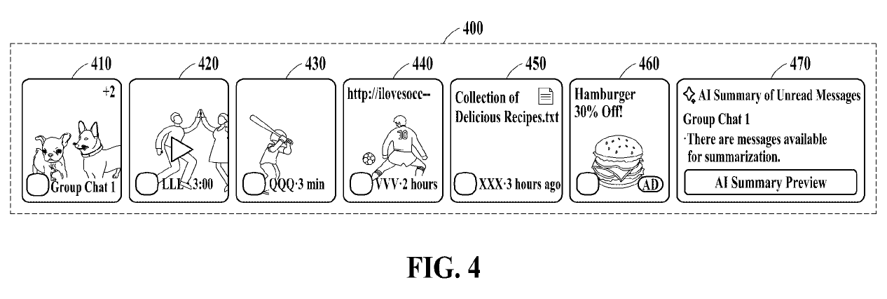

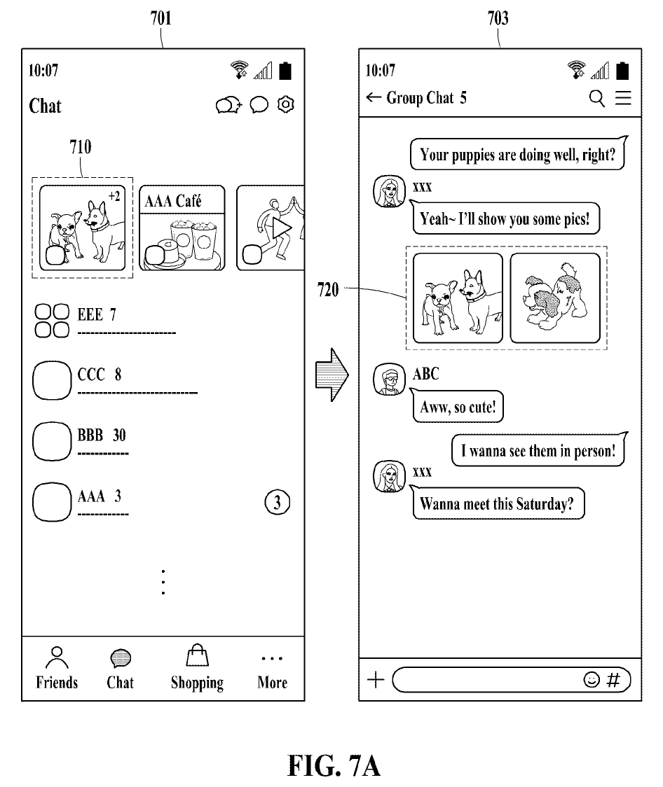

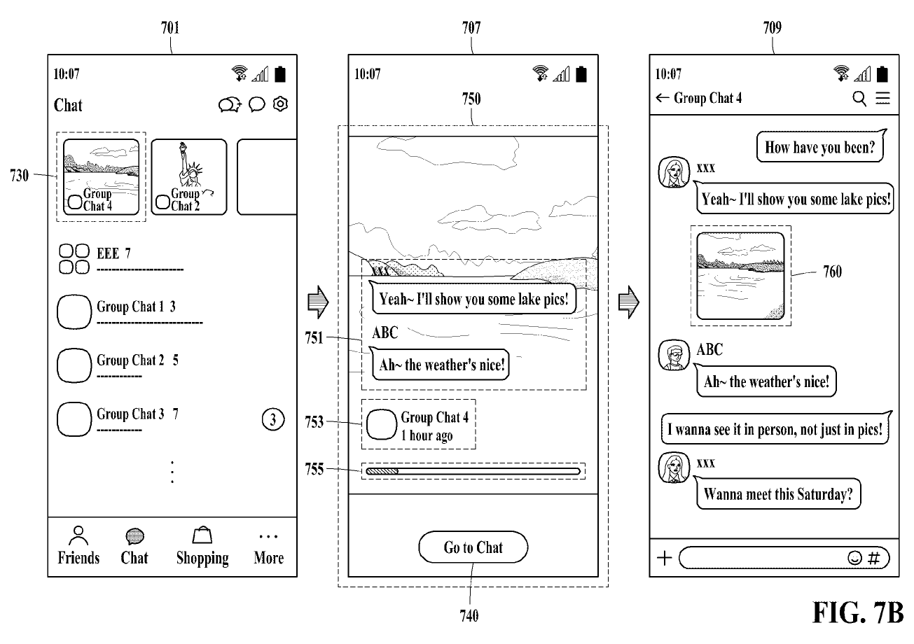

The preview may be displayed through a separate interface, in addition to the interfacing object. The preview displayed on the interfacing object will be described in more detail below with reference to FIG. 4, and the preview displayed on the interface will be described in more detail below with reference to FIG. 7B.

The method of operating a terminal using an instant messaging service, according to an embodiment, may include operation 230 of displaying a list view including at least one first element corresponding to at least one chatroom and a second element including at least one interfacing object.

The list view may correspond to a view in a UI for displaying elements in a scrollable list format by arranging the elements in a predefined direction. Each of the at least one first element and the second element may be a list element forming the list view. The first element may be generated corresponding to each of a plurality of chatrooms. The second element may be generated to arrange at least one interfacing object for displaying a preview and may correspond to a sub-list view including at least one interfacing object as an element. According to an embodiment, the second element may include a predefined number of interfacing objects from among the at least one interfacing object. The predefined number may be set by the server 120 or by the user of the terminal 110. The arrangement of the at least one interfacing object within the second element will be described in more detail below with reference to FIGS. 5A and 5B.

The terminal 110 may generate the at least one first element corresponding to the at least one chatroom and the second element including the at least one interfacing object and may display the at least one first element and the second element on the list view. The list view will be described in more detail below with reference to FIG. 3.

The terminal 110 may provide an interfacing object configured to display a preview of an instant message transmitted and received within the instant messaging service and may enable a user to rapidly recognize new content in a specific chatroom and to naturally enter the chatroom. Accordingly, a visit rate and a dwell time of a chat tab may increase, and non-purpose-driven traffic, generated as users naturally enter based on presented or exposed information without a clear objective or a specific destination, may be effectively secured.

FIG. 3 is a diagram illustrating a list view, according to an embodiment.

Referring to FIG. 3, a screen 300 including a list view is illustrated. The screen 300 may include a navigation bar 310 and a list view 320 for displaying a plurality of tabs provided by an instant messaging service. The list view 320 may include a second element 330 and first elements 340, and the first elements 340 may include a first element 345.

The first element 345 may be generated corresponding to each of a plurality of chatrooms. In addition, the second element 330 may include at least one interfacing object. The terminal 110 may configure the list view 320 by disposing the second element 330 above the first elements 340. The at least one interfacing object included in the second element 330 will be described in detail below with reference to FIG. 4.

Although not illustrated in the drawings, for convenience of description, according to an embodiment, a hidden menu may be displayed when a long-press operation is performed on the at least one interfacing object included in the second element 330. When a long-press input is detected, a context menu providing various functions, such as hiding, pinning, and restoring, may be displayed in a pop-up form. Accordingly, a user of the terminal 110 may easily hide or manage a specific interfacing object.

Although not illustrated in the drawings, for convenience of description, according to an embodiment, when the second element 330 is first displayed on the terminal 110, an info interface corresponding to the second element 330 may be displayed. The info interface may include informational text describing functions provided through the second element 330. For example, the informational text may indicate that photos, videos, files, and link messages received within the last 24 hours may be viewed, that a corresponding message may be selected to navigate to a chatroom, that a message may be hidden, and that the message may automatically disappear after 24 hours.

The first elements 340 and the second element 330 may be scrollable in a first direction within the list view 320. For example, the second element 330 and the first elements 340 included in the list view 320 displayed on the screen 300 may be scrollable in a vertical direction. In response to receiving a vertical scroll input from a user, the first elements 340 and the second element 330 included in the list view 320 may be moved in the vertical direction and displayed. According to an embodiment, the second element 330 may not be displayed when a predefined portion of the second element 330 is obscured in response to scrolling in the first direction of the list view 320. In this case, when the predefined portion of the second element 330 is exposed in response to scrolling in an opposite direction, the second element 330 may be displayed again. Alternatively, the second element 330 may be fixed, and only the first elements 340 may be moved and displayed in response to scrolling in the first direction.

The at least one interfacing object included in the second element 330 may be scrollable in a second direction, which is different from the first direction, within the second element 330. For example, the at least one interfacing object within the second element 330 displayed on the screen 300 may be scrollable in a horizontal direction. An initial scroll state of the second element 330 may be set such that an interfacing object having a first order is displayed first. In response to receiving a scroll input in the second direction corresponding to the second element 330, the initial scroll state may be changed to a changed scroll state. The changed scroll state may be maintained in the absence of a user input.

The changed scroll state may return to the initial scroll state when a predefined trigger condition occurs. For example, the changed scroll state may return to the initial scroll state upon receiving a user input corresponding to the chat tab 315. Alternatively, the changed scroll state may return to the initial scroll state when being moved above the list view 320 upon receiving a user input corresponding to a top portion of the screen of the terminal 110 after a downward scroll input in the first direction within the list view 320.

In addition, the changed scroll state may return to the initial scroll state in response to obtaining a second instant message. For example, when the instant messaging service is operating as a background app and the chat tab 315 is accessed within the instant messaging service, the changed scroll state may return to the initial scroll state. In addition, the changed scroll state may return to the initial scroll state when the user accesses the chat tab 315 while accessing another tab within the instant messaging service, or when the user re-accesses the chat tab 315 via a back button input while a screen other than a screen of the chat tab 315 is being displayed.

However, when one of the at least one interfacing object included in the second element 330 is selected and a separate interface is displayed, and thereafter a screen of a corresponding chatroom is displayed via the separate interface, and the second element 330 is displayed again upon receiving a back button input, the changed scroll state may be maintained. Accordingly, by maintaining the changed scroll state even after transitions between interfaces, continuity of content navigation and consistency of user experience may be improved.

FIG. 4 is a diagram illustrating an interfacing object included in a second element, according to an embodiment.

Referring to FIG. 4, an entire second element 400 according to an embodiment is illustrated. According to an embodiment, the second element illustrated in the drawings of the present disclosure may correspond to a portion of the entire second element 400.

The entire second element 400 may include interfacing objects 410, 420, 430, 440, 450, 460, and 470. Each of the interfacing objects 410, 420, 430, 440, 450, 460, and 470 may be generated to display at least one of chatroom information including a corresponding second instant message, sender information of the corresponding second instant message, receipt time information of the corresponding second instant message, preview data based on at least one type, or a combination thereof. For example, the interfacing object 410 may display a profile image of a group chatroom and a name of the group chatroom, “Group Chat 1”, and may display an image of a puppy as preview data of the corresponding second instant message. In addition, the interfacing object 420 may correspond to an object generated based on an instant message transmitted and received within a 1:1 chatroom and may display a sender name “Lee Hana” and a sender profile and may display “3 hours ago” as the receipt time information.

Preview data of each of the interfacing objects 410, 420, 430, 440, and 450 may be generated based on a content type included in the corresponding second instant message. Although, in the entire second element 400, for convenience of description, the respective interfacing objects being generated based on different types are illustrated, at least a portion of the at least one interfacing object included in the second element may include overlapping types. In addition, the at least one interfacing object included in the second element may correspond to an interfacing object corresponding to at least some of the types included in the entire second element 400.

The interfacing object 410 represents that content included in the corresponding second instant message is a bundled image. The interfacing object 410 may be displayed using preview data for displaying the bundled image. Preview data for displaying the bundled image in advance may be generated based on any one of a plurality of single images included in the bundled image. According to an embodiment, the any one image may correspond to an image first selected by a user of a terminal that transmits the message. The preview data may be generated based on image data in which a size, a resolution, or a combination thereof of the single image is adjusted according to attribute information of the interfacing object. Alternatively, the preview data for displaying the bundled image in advance may include data for connecting the plurality of images included in the bundled image in a slide format or an animation format. The preview data for displaying the bundled image in advance may be generated to indicate the number of single images included in the bundled image. For example, “+2” on the interfacing object 410 may indicate that the number of single images included in the bundled image of the corresponding instant message is two.

The interfacing object 420 represents that content included in the corresponding second instant message is a video. The interfacing object 420 may be displayed using preview data for displaying the video. The preview data for displaying the video may be generated based on a captured image at a specific point within the video. Alternatively, the preview data for displaying the video may include an auto-play preview clip that is automatically played when the interfacing object 420 is rendered on a screen of the terminal 110 and displayed to the user. In this case, preview video data may be automatically played in a loop or over a limited-duration segment with sound muted, and the video data may be provided via streaming or pre-download depending on network conditions or user settings. According to an embodiment, the preview data for displaying the video may be generated such that an icon, such as a play button (▷), indicating that the content is a video, is displayed.

The interfacing object 430 represents that content included in the corresponding second instant message is a single image. The interfacing object 430 may be displayed using preview data for displaying the single image. Preview data for displaying a single image may be generated based on the single image. The preview data for displaying the single image may be generated based on image data in which a size, a resolution, or a combination thereof of the single image is adjusted based on attribute information of the interfacing object.

The interfacing object 410 including a bundled image, the interfacing object 420 including a video, and the interfacing object 430 including a single image, as visual content, may be displayed based on original data or thumbnail data loaded on the terminal 110 corresponding to a second instant message. When both the original data and the thumbnail data exist on the terminal 110, the preview data may be generated based on the original data.

The interfacing object 440 represents that content included in the corresponding second instant message is link information. The interfacing object 440 may be displayed using preview data for displaying the link information. The link information may be information that indicates a resource, the location of the resource, or a link to the resource, and may include, for example, a URL or an address. The resource may include various types of data and services accessible via a web or an app and may include, for example, at least one of an app page, a web page, an image, a video, a file, or an API endpoint. The terminal 110 may access the resource via the link information.

Information associated with the resource may be extracted from data for describing or managing the resource or data included in the resource, such as a meta tag and/or an open graph (OG) tag of the resource. The information associated with the resource may include resource title information, resource image information, or a combination thereof. According to an embodiment, the terminal 110 may call a scrap server to extract the information associated with the resource. The scrap server may correspond to a server configured to access a specified resource, parse metadata of the resource (e.g., a meta tag or an OG tag), and provide a parsing result to the terminal 110.

The preview data for displaying the link information may include image information extracted from the resource corresponding to the link information, resource title information, the link information, or a combination thereof. The preview data for displaying the link information may include only the link information when data for describing or managing the resource or data included in the resource does not exist. According to an embodiment, when the link information is reported by participants of a chatroom in which the link information is received, the interfacing object 440 may be deleted.

The interfacing object 450 represents that content included in the corresponding second instant message is a document file. The interfacing object 450 may be displayed using preview data for displaying the document file. The preview data for displaying the document file may include data indicating attributes of the document file. For example, the preview data for displaying the document file may include a title of the document file, a document type (e.g., docx, pptx, or pdf), and a file size. In addition, the preview data for displaying the document file may include a thumbnail image corresponding to a first page or a cover of the document, and a text snippet for preview.

The interfacing object 460 may be an interfacing object included in the second element and may correspond to an interfacing object for advertising. The interfacing object for advertising, upon receiving a user selection input, may indicate the location of an advertising resource or provide a link to the advertising resource. The advertising resource may vary based on a country, a user, language settings, user interests, search or message history, network conditions, or service usage patterns.

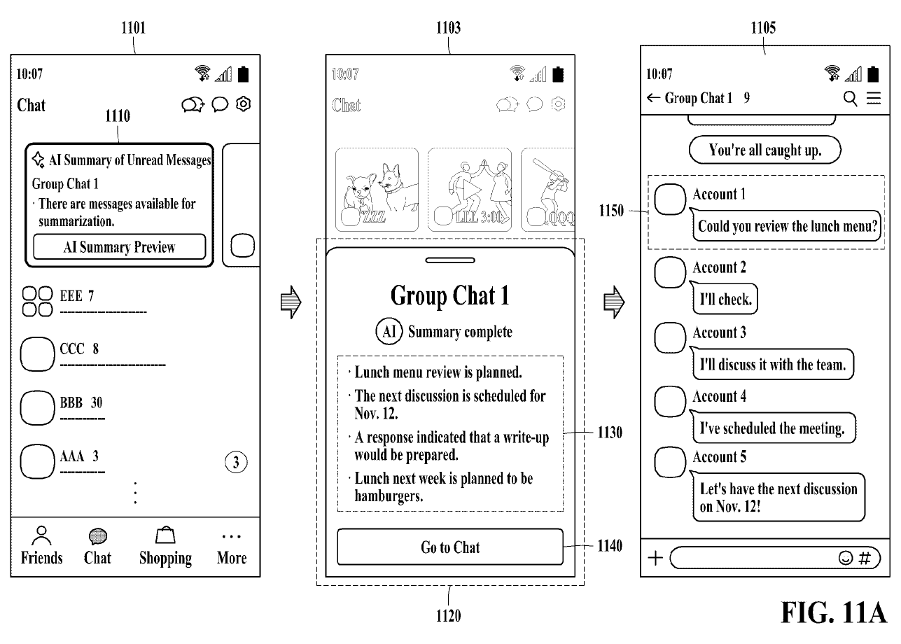

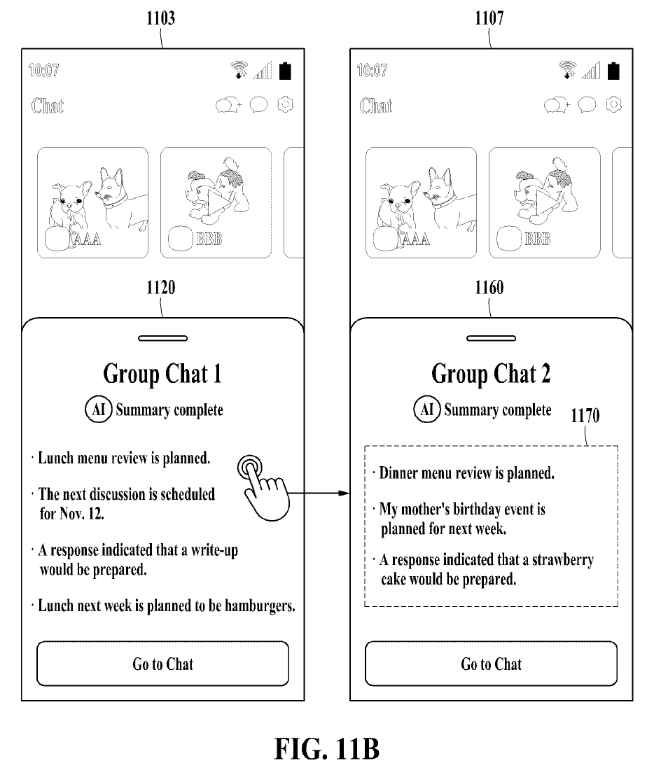

The interfacing object 470 may be an interfacing object included in the second element and may correspond to a third interfacing object for displaying summary data. The third interfacing object may be implemented by displaying preview data that informs a user that a plurality of unread instant messages exists and that summary data may be generated based on the unread instant messages. The third interfacing object will be described in more detail below with reference to FIG. 11.

FIGS. 5A and 5B are diagrams illustrating interfacing objects displayed within a second element, according to an embodiment.

The terminal 110 may generate a second element including the interfacing objects, based on a first criterion according to a receipt time of an instant message and second criteria corresponding to the types.

Before generating an interfacing object, the terminal 110 may sort at least one second instant message based on the first criterion according to receipt time information of the at least one second instant message. The terminal 110 may generate an interfacing object corresponding to at least one second instant message from among the sorted at least one second instant message. According to an embodiment, the terminal 110 may generate interfacing objects corresponding to a predefined number of instant messages from among the at least one second instant message.

For example, referring to FIG. 5A, a chatroom screen 501 in which instant messages are transmitted and received, and a screen 503 in which interfacing objects 541 and 543 generated based on the instant messages transmitted and received in the chatroom are displayed on a second element 540 are illustrated.

Referring to the chatroom screen 501, the instant messages transmitted and received within the chatroom may be displayed in chronological order. The terminal 110 may sort the instant messages transmitted and received within the chatroom in chronological order. An instant message 510 including a bundled image may correspond to an instant message that is sorted prior to an instant message 520 including link information. The terminal 110 may generate the interfacing object 543 corresponding to the instant message 510 including the bundled image. In addition, the terminal 110 may generate the interfacing object 541 corresponding to the instant message 520 including the link information.

After generating the interfacing objects, the terminal 110 may display at least one interfacing object within the second element 540 based on a sorting order of the corresponding second instant messages. For example, the interfacing object 541 may be arranged and displayed with a higher priority than the interfacing object 543 within the second element 540.

Although not illustrated in the drawings, for convenience of description, the terminal 110 may receive, from a user, a first input corresponding to one of the interfacing objects, and upon receiving the first input, may sort the interfacing objects on the second element such that remaining interfacing objects are arranged with higher priority than the one interfacing object. In addition to the at least one interfacing object being sorted based on the receipt time information of the corresponding second instant message, an interfacing object that has not received a user selection input may be arranged with higher priority than an interfacing object that has received the user selection input. For example, in response to a user selection input corresponding to the interfacing object 541, the interfacing object 541 may be arranged with lower priority than the interfacing object 543 and the interfacing object 545. Alternatively, the interfacing object 541 may be arranged last within the second element 540. When a plurality of interfacing objects has received selection inputs, the plurality of interfacing objects may be re-arranged according to the receipt time information.

The terminal 110 may determine priorities of the at least one second instant message based on at least one type and at least one second criterion corresponding to the at least one type. The terminal 110 may sort the at least one interfacing object based on the determined priorities.

A predefined second criterion corresponding to the at least one type may include a criterion for setting priorities of each of the at least one second instant message differently based on whether a common attribute is included. According to an embodiment, the common attribute may include a content type, chatroom information, and/or sender and receiver account information.

For example, the second criterion may include a criterion for setting a priority of one of a plurality of second instant messages relatively high and assigning relatively low priorities to the remaining second instant messages when the plurality of second instant messages having the same content type exists consecutively. Alternatively, when the plurality of second instant messages corresponding to the same chatroom or account exists consecutively, the second criterion may include a criterion for setting a priority of one second instant message relatively high and assigning relatively low priorities to the remaining second instant messages.

Alternatively, according to an embodiment, the at least one second criterion corresponding to the at least one type may include a criterion for setting priorities of each of the at least one second instant message differently based on receipt time for each type of the at least one second instant message. For example, the second criterion may include a criterion that assigns a relatively higher priority as an expiration (e.g., 30 days from a date of receipt) date of content, determined based on a receipt time for each content type included in the second instant message, becomes closer.

The terminal 110 may determine a final priority considering all priorities set according to at least one predefined criterion corresponding to the at least one type.

For example, referring to FIG. 5B, a screen 505 may represent a chatroom screen in which instant messages corresponding to second instant messages are transmitted and received. The screen 505 may represent a case in which at least one second instant message 550, each including a single image, is transmitted and received in the chatroom. The at least one second instant message 550 may include a second instant message 551 including video content and second instant messages 553 and 555 including single image content.

In determining a first priority, the second instant message 555, the second instant message 553, and the second instant message 551 may have priorities in descending order based on receipt time information. In this case, in determining a second priority, the second instant message 555 and the second instant message 553, which include single image content, may each be assigned different priorities. The terminal 110 may determine a final priority considering all priorities of each second instant message. According to the first priority and the second priority, the final priority may be determined in the order of the second instant message 555, the second instant message 551, and the second instant message 553.

A screen 507 may illustrate a result in which interfacing objects 571 and 573 are arranged within a second element 570 based on priorities. The interfacing object 571 may be generated corresponding to the second instant message 555, and the interfacing object 573 may be generated corresponding to the second instant message 551. The interfacing object 571 may be arranged with higher priority than the interfacing object 573, based on the priority of the second instant message 555 being higher than that of the second instant message 551.

Accordingly, even when identical or similar content is repeatedly received within a chatroom, diversity of interfacing objects displayed in the second element may be ensured by sorting and eliminating second instant messages based on the priorities. In addition, by preventing duplicate display of similar content, a richer and more efficient information browsing experience may be provided to a user.

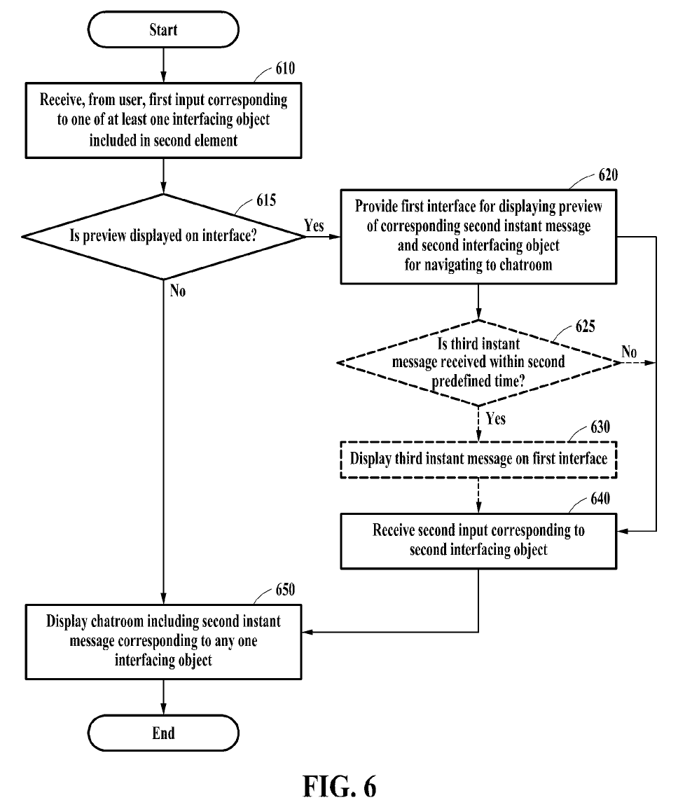

FIG. 6 is a flowchart illustrating a method of navigating to a chatroom in response to selection of an interfacing object, according to an embodiment.

According to an embodiment, the method of navigating to a chatroom in response to selection of an interfacing object (hereinafter, a “chatroom navigation method”) may be performed after operation 230 of FIG. 2.

Referring to FIG. 6, the chatroom navigation method may include operation 610 of receiving, from a user, a first input corresponding to one of at least one interfacing object included in a second element.

The terminal 110 may perform operation 620 or operation 650 depending on a determination 615 of whether to display a preview corresponding to a second instant message on a separate interface. The determination 615 of whether to display the preview may vary depending on user settings of the terminal 110 or settings of the server 120. When the preview corresponding to the second instant message is to be displayed on the separate interface, operation 620 may be performed, and when the preview is not to be displayed, operation 650 may be performed. Alternatively, according to an embodiment, operation 650 may be performed without the determination 615 of whether to display the preview corresponding to the second instant message on the separate interface.

The chatroom navigation method may include operation 620 of providing a first interface for displaying a preview of a corresponding second instant message and a second interfacing object for navigating to a chatroom.

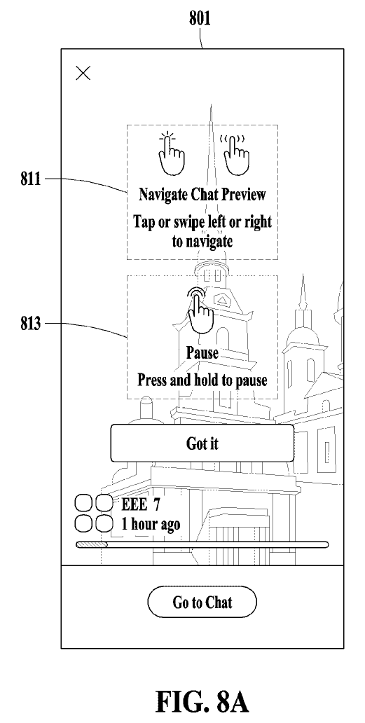

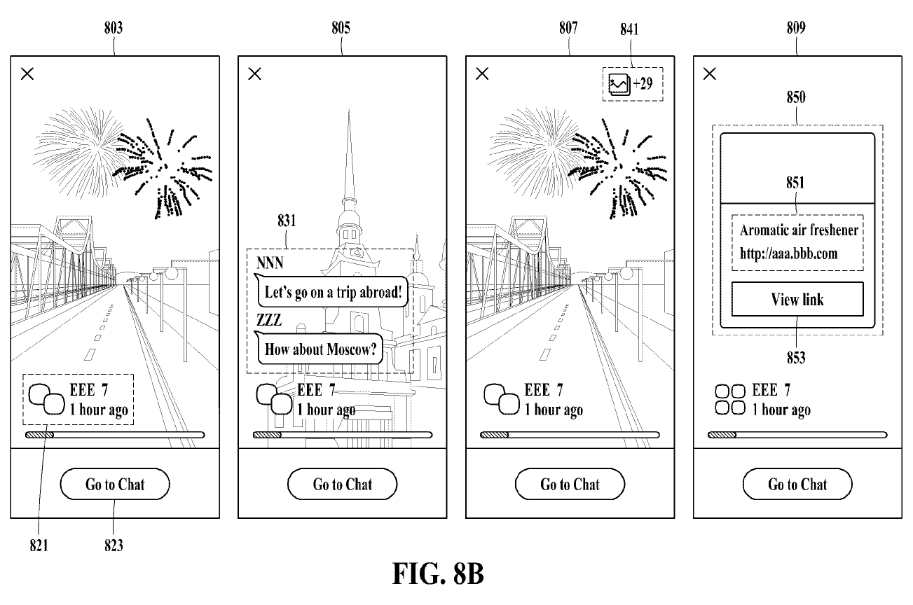

The terminal 110 may display the preview of the corresponding second instant message through the first interface. The preview displayed through the first interface will be described in more detail below with reference to FIG. 8. In addition to the preview, the terminal 110 may display the second interfacing object on the first interface. The second interfacing object may be associated with identification information or an address of a chatroom to which the corresponding second instant message belongs.

The chatroom navigation method may further include operation 630 of displaying a third instant message on the first interface based on a determination 625 of whether the third instant message is received within a predefined time range. Operation 630 may be omitted according to embodiments.

In response to receiving the first input, the terminal 110 may obtain, from among the first instant messages, at least one third instant message received within the predefined time range from a receipt time of the corresponding second instant message in the chatroom. The third instant message may include a message received within a predefined time before the receipt time of the second instant message, a message received within a predefined time after the receipt time, or a combination thereof. For example, the terminal 110 may obtain the at least one third instant message received within one hour before (e.g., 1 o’clock) the receipt time (e.g., 2 o’clock) of the corresponding second instant message. Alternatively, the terminal 110 may obtain the at least one third instant message received within one hour after (e.g., 3 o’clock) the receipt time (e.g., 2 o’clock) of the corresponding second instant message.

In addition, the number of third instant messages that may be obtained may be limited according to a predefined number criterion. The terminal 110 may obtain, as the third instant messages, a predefined number of messages from among instant messages received before or after the receipt time of the corresponding second instant message. For example, when a total of 10 instant messages are received between 2:00 and 3:00 (or between 1:00 and 2:00) relative to the receipt time of the corresponding second instant message, and the predefined number criterion is 3, the terminal 110 may obtain, as the third instant messages, three instant messages that are first received within the corresponding time. The predefined time range and the predefined number criterion may be set by the server 120 or by the user of the terminal 110. The terminal 110 may display the at least one third instant message on the first interface based on whether the at least one third instant message is obtained.

The chatroom navigation method may include operation 640 of receiving a second input corresponding to the second interfacing object. When the user of the terminal 110 intends to access a chatroom to view an original message while viewing a preview on the first interface, the user may select the second interfacing object. The terminal 110 may receive the user’s selection input as the second input and perform operation 650.

The chatroom navigation method may include operation 650 of displaying a chatroom including a second instant message corresponding to any one interfacing object. The second instant message may include chatroom identification information identifying a chatroom in which the second instant message is included. The terminal 110 may detect an input event for the second interfacing object and perform a chatroom transition based on chatroom identification information associated with the second interfacing object.

The second instant message may include log data used for message tracking in the terminal 110, the server 120, or a combination thereof. The log data may correspond to record data including an identifier of the message, reception or transmission time information (e.g., a timestamp), and additional metadata. The terminal 110 may determine the location of the corresponding second instant message within the chatroom based on log data of the second instant message. For example, the terminal 110 may determine the location of the corresponding second instant message based on message identifier data included in the log data.

The terminal 110 may display the chatroom based on the determined location such that the corresponding second instant message is displayed. The corresponding second instant message may be displayed with a separate animation effect (e.g., a speech bubble shaking effect). In addition, when the chatroom is displayed and viewed, and at least one unread instant message included in the chatroom exists, the at least one unread instant message may be marked as read.

FIGS. 7A and 7B are diagrams illustrating a method of displaying a chatroom, according to an embodiment.

Referring to FIG. 7A, a case in which a chatroom screen is displayed in response to selection of an interfacing object without displaying a preview of a second instant message on a separate interface is illustrated. A screen 701 displaying a second element including at least one interfacing object and a chatroom screen 703 transitioned from the screen 701 in response to selection of one interfacing object 710 are illustrated.

The terminal 110 may receive a second input, from a user, corresponding to any one interfacing object 710 from among the at least one interfacing object included in the second element. In response to receiving the second input, the terminal 110 may transition to the chatroom screen 703 corresponding to the interfacing object 710. The screen 703 may display a second instant message 720 corresponding to the interfacing object 710. The second instant message 720 may be displayed with an animation effect.

Referring to FIG. 7B, a case in which a chatroom screen is displayed via a separate interface that provides a preview of a second instant message in response to selection of an interfacing object is illustrated. A screen 701 displaying a second element including at least one interfacing object, a screen 707 displaying an interface provided in response to selection of one interfacing object 730, and a chatroom screen 709 transitioned in response to selection of a second interfacing object 740 are illustrated.

The terminal 110 may receive a first input, from the user, corresponding to any one interfacing object 730 from among the at least one interfacing object included in the second element displayed on the screen 705. In response to receiving the first input, the screen 705 may transition to the screen 707 displaying a first interface 750 for providing a preview of a second instant message 760 corresponding to the interfacing object 730. The first interface 750 may display at least one third instant message 751 and may display information 753 associated with the second instant message 760 corresponding to the interfacing object 730, including chatroom information, reception information, and profile information. The first interface 750 may be configured to be displayed for a third predefined time, and elapse of the third predefined time may be visually indicated through a progress bar 755. The first interface 750 will be described in more detail below with reference to FIG. 8.

The screen 707 may receive the second input, from the user, corresponding to the second interfacing object 740 included in the first interface 750. In response to receiving the second input, the terminal 110 may transition the screen 707 to the chatroom screen 709 displaying a chatroom to which the second instant message 760 corresponding to the interfacing object 730 belongs. The chatroom screen 709 may display the second instant message 760 corresponding to the interfacing object 730. The second instant message 760 may be displayed with an animation effect.

FIGS. 8A and 8B are diagrams illustrating a method of providing a first interface, according to an embodiment.

According to an embodiment, the first interface may be displayed on the terminal 110 for a third predefined time. In response to expiration of the third predefined time, the first interface may transition to a second interface configured to display a preview corresponding to an interfacing object arranged after the one interfacing object within a second element. The first interface may correspond to an interface displayed in a current state, and the second interface may correspond to an interface displayed in a transitioned state.

However, elapse of the third predefined time may be suspended for a duration corresponding to a long-press input in response to the long-press input by a user. The long-press input may include input generated by the user continuously touching the same location for a predefined time or longer. In response to the long-press input, the first interface may transition to the second interface when the third predefined time expires after the long-press input ends. In this case, the third predefined time may be set by the server 120 or by the user of the terminal 110.

In addition, in response to a swipe input from the user, the first interface may transition to the second interface configured to display a preview corresponding to an interfacing object arranged before or after the one interfacing object within the second element. A swipe input may include input generated through a gesture in which a user continuously moves a finger or an input tool in one direction across a screen. According to an embodiment, the swipe input may be replaced with a selection input on the right area or the left area of a touch screen included in the terminal 110.

For example, referring to FIG. 8B, an interface 803, an interface 805, an interface 807, and an interface 809 may each correspond to one of a plurality of interfacing objects arranged within a second element, and these interfaces may be sequentially transitioned and displayed in response to a swipe input. When the interface 803 is a first interface displayed upon receiving a first input, the interface 803 may transition to the interface 805 upon receiving a swipe input corresponding to the right area of the interface 803. In this case, the transitioned interface 805 may correspond to a second interface. While in a state in which the interface 805 is displayed, the interface 805 may transition to the interface 807 upon receiving a swipe input corresponding to the right area of the interface 805 and may transition back to the interface 803 upon receiving a swipe input corresponding to the left area thereof. In addition, while an interface corresponding to the last-arranged interfacing object among at least one interfacing object included in the second element is being displayed, when a swipe input for displaying a next interface is received, display of the interfaces may be terminated. Alternatively, the interface may transition to an interface corresponding to the first-arranged interfacing object within the second element.

According to an embodiment, referring to FIG. 8A, when a user first enters a first interface screen upon receiving the first input, a guidance interface 801 may be displayed to provide a visual description of a gesture input method. The guidance interface 801 may include interface elements for guiding a long-press input or a swipe input. The guidance interface 801 may be displayed as an overlay on the first interface for displaying the second instant message. The guidance interface 801 may include an interface element 811 for guiding a swipe input and an interface element 813 for guiding a long-press input.

Referring again to FIG. 8B, the interface 803, the interface 805, the interface 807, and the interface 809 may each be displayed using preview data of a corresponding second instant message. The preview data displayed on an interface may include the same data as the preview data for displaying an interfacing object, or data obtained by adjusting the preview data for displaying the interfacing object for display on the interface.

The interface 803 may correspond to the first interface for displaying a preview of a second instant message including single image content. The interface 803 may display preview data (e.g., an image of fireworks) of the second instant message. Although not illustrated for convenience of description, when content included in the second instant message corresponds to a video, the interface 803 may output preview video data that is automatically played when rendered on a screen of the terminal 110 and displayed to the user.

The interface 803 may display chatroom information 821 corresponding to the second instant message. Based on the chatroom information 821, the user may visually identify basic information about a chatroom (e.g., a group meeting chatroom) in which the corresponding second instant message is shared. The interface 803 may include a button 823 (e.g., “Go to Chat”) as a second interfacing object for entering the chatroom. In response to receiving a second input corresponding to the button 823, the screen of the terminal 110 may transition to a chatroom including the corresponding second instant message.

The interface 805 may correspond to a case in which at least one third instant message exists and may correspond to the first interface for displaying a preview of a second instant message including single image content. In addition, the interface 805 may include an interface for displaying a third instant message 831. The interface 805 may include chatroom information and a button for entering the chatroom, similar to the interface 803.

The interface 807 may correspond to the first interface for displaying a preview of a second instant message including bundled image content. The interface 807 may include an interface element 841 indicating the number of single images included in the bundled image.

The interface 809 may correspond to the first interface for displaying a preview of a second instant message including link information content. The interface 809 may include a preview data display interface 850 for displaying preview data of the second instant message. The preview data display interface 850 may display information 851 regarding content included in the second instant message. The preview data display interface 850 may include an interfacing object 853 for accessing the link information.

In addition to a second instant message including link information content, a second instant message including non-visual content (e.g., multimedia content excluding visual content such as images, bundled images, or videos) may also be displayed in a form similar to the preview data display interface 850.

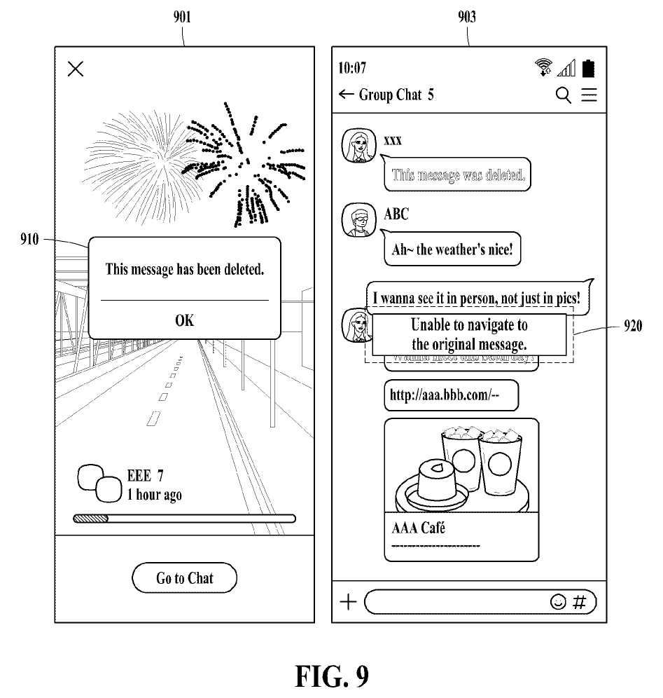

FIG. 9 is a diagram illustrating a method of providing a first interface in response to deletion of an instant message, according to an embodiment.

According to an embodiment, a first instant message and a second instant message may synchronize, in real time, a state of a chatroom and a plurality of instant messages included in the chatroom. Accordingly, when a specific instant message is deleted within the chatroom, a deletion state may also be reflected in the first interface corresponding to the specific instant message.

However, due to network delays or processing timing issues, the first interface may remain even though the corresponding second instant message has been deleted. In this case, when a user selects an interfacing object for displaying the remaining first interface, a guidance interface, indicating that the first interface may not be displayed, may be displayed. For example, referring to a screen 901 of FIG. 9, a confirmation pop-up 910 stating “This message has been deleted.” may be displayed, and the first interface may be closed in response to a confirmation input.

In addition, after receiving a second input corresponding to a second interfacing object on the first interface, when the corresponding second instant message has been deleted and thus may not be displayed even after navigating to the corresponding chatroom, a guidance message, indicating that the corresponding second instant message may not be displayed, may be displayed. Referring to a screen 903 of FIG. 9, a toast message 920 stating “Unable to navigate to the original message.” may be displayed. In this case, when navigating to the chatroom, when at least one unread instant message exists in the chatroom, the terminal 110 may navigate to a location at which the unread instant messages start. In addition, when no unread instant message exists in the chatroom (i.e., only read messages exist), the terminal 110 may enter the location of a most recent message in the chatroom.

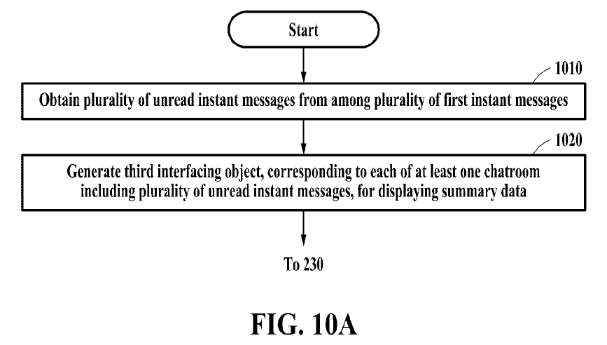

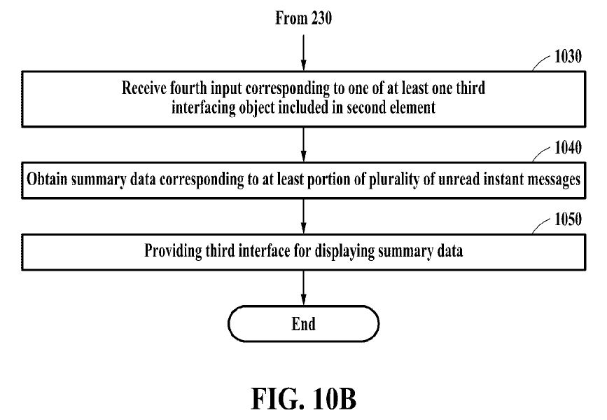

FIG. 10A is a flowchart illustrating a method of generating an interfacing object for providing summary data, according to an embodiment.

The method of generating an interfacing object for providing summary data according to an embodiment may be performed corresponding to operations 210 and 220 of FIG. 2.

Referring to FIG. 10A, the method of generating an interfacing object for providing summary data according to an embodiment may include operation 1010 of obtaining a plurality of unread instant messages from among a plurality of first instant messages. In this case, the plurality of unread messages may include instant messages that are marked as unread from among the first instant messages, regardless of whether the messages were received within a predefined time. The plurality of unread messages may be obtained corresponding to each of a plurality of chatrooms.

The method of generating an interfacing object for providing summary data according to an embodiment may include operation 1020 of generating at least one third interfacing object, corresponding to each of at least one chatroom including at least a portion of the plurality of unread instant messages, for displaying summary data of at least a portion of the plurality of unread instant messages.

The plurality of unread instant messages may be included in at least one of the plurality of chatrooms in which a user of the terminal 110 participates. Unread instant messages included in each of the at least one chatroom may correspond to at least a portion of the plurality of unread instant messages. For example, when a total of 10 unread instant messages exist and an account of the terminal 110 participates in chatroom A, chatroom B, and chatroom C, 5 unread instant messages may exist in chatroom A and 5 unread instant messages may exist in chatroom B. The summary data may include summary text generated using a language model. The generation of the summary data will be described in detail below with reference to FIG. 10B.

A third interfacing object may be generated to provide summary data corresponding to a chatroom to the user. The third interfacing object may be implemented by displaying preview data that informs the user that a plurality of unread instant messages exists and that summary data may be generated based on the unread instant messages. The third interfacing object may be included in the second element together with at least one interfacing object generated through operation 220. The third interfacing object will be described in detail below with reference to FIG. 11.

FIG. 10B is a flowchart illustrating a method of generating summary data, according to an embodiment.

The method of generating summary data according to an embodiment may be performed after operation 230 of FIG. 2.

The method of generating summary data according to an embodiment may include operation 1030 of receiving, from a user, a third input corresponding to one of third interfacing objects included in a second element. The second element may include the third interfacing object generated through operation 1030 together with at least one interfacing object generated through operation 220. The terminal 110 may receive, from the user, the third input as a selection input corresponding to a third interfacing object among a plurality of interfacing objects included in the second element.

The method of generating summary data according to an embodiment may include operation 1040 of receiving summary data corresponding to at least a portion of a plurality of unread instant messages in a corresponding chatroom, in response to the third input.

The terminal 110 may collect and synchronize the plurality of unread instant messages in the chatroom corresponding to the third interfacing object, in response to the third input. Thereafter, the terminal 110 may transmit at least a portion of the plurality of unread instant messages to a language model server. Alternatively, the terminal 110 may transmit a summary request to the server 120, and the server 120 may transmit the summary request of the terminal 110 to the language model server. Alternatively, the terminal 110 may obtain the summary data by inputting at least a portion of the plurality of unread instant messages into a language model module mounted on the terminal 110. The terminal 110 may optimize system resource consumption by providing summary information in response to a selection input from the user, thereby reducing unnecessary computation requests and network traffic to the language model server.

According to an implementation, the terminal 110 may transmit only a predefined number of messages among the plurality of unread instant messages to the language model server. The predefined number of messages among the plurality of unread instant messages may be determined based on receipt times. For example, the terminal 110 may select a predefined number of unread instant messages starting from a most recently received message and transmit the selected unread instant messages to the language model server.

The language model server may generate the summary data based on the plurality of received unread instant messages. The language model server may be a server configured to receive instant messages as input, perform natural language processing based on a large language model (LLM), and generate summary data for the instant messages. The language model server may analyze a plurality of instant messages to perform processing such as extracting key content, classifying by topic, or identifying semantic relationships among the plurality of instant messages. Accordingly, the language model server may generate summary data to be provided to the user. The language model server may be included in the server 120 or may be a third server associated with the server 120.

The terminal 110 may receive the generated summary data from the language model server when the language model server completes generation of the summary data in response to the plurality of unread instant messages transmitted in operation 1040. The summary data may include, but is not limited to, a keyword set generated by extracting keywords from the plurality of unread instant messages, a summary generated by selecting key sentences from the plurality of instant messages, a title or a subtitle representing a subject or a topic of the plurality of instant messages, a brief narrative generated by summarizing a conversation flow of the plurality of instant messages, or metadata additionally provided by analyzing an emotional state of the plurality of instant messages.

The method of generating summary data according to an embodiment may include operation 1050 of providing a third interface for displaying summary data and a fourth interfacing object for navigating to a corresponding chatroom.

The terminal 110 may generate the fourth interfacing object for navigating to a chatroom including unread instant messages. The terminal 110 may generate and provide the third interface for displaying the summary data received in operation 1040 and the generated fourth interfacing object. In response to receiving a selection input from the user, the fourth interfacing object may cause a screen transition by navigating to the chatroom including unread instant messages.

In response to receiving a selection input corresponding to the fourth interfacing object from the user, the terminal 110 may extract log information of a first received unread instant message from among the plurality of unread instant messages. The terminal 110 may obtain the location of the first received unread instant message based on the log information of the first received unread instant message. The terminal 110 may display the chatroom such that the first received unread instant message is displayed based on the obtained location.

FIG. 11A is a flowchart illustrating a method of generating summary data, according to an embodiment.

Referring to FIG. 11A, a screen 1101 displaying a third interfacing object 1110 included in a second element, a screen 1103 displaying summary data 1130 and a fourth interfacing object 1140 via a third interface 1120, and a screen 1105 displayed by navigating to a chatroom in response to a selection input for the fourth interfacing object 1140 are illustrated.

On the screen 1101, the third interfacing object 1110 may be included in the second element together with at least one interfacing object. The third interfacing object 1110 may be displayed based on preview data indicating that a plurality of unread instant messages exists and that summary data may be generated therefrom. For example, the third interfacing object 1110 may be displayed based on preview data including text (e.g., “There are messages available for summarization.”, “AI Summary of Unread Messages”, “AI Summary Preview”) indicating that summary data may be generated from corresponding chatroom group information (e.g., “Group Chat 1”). The screen 1101 may transition to the screen 1103 in response to a selection input or a third input corresponding to the third interfacing object 1110 from the user.

On the screen 1103, a screen on which the third interface 1120 is provided in response to the selection input or the third input from the user is illustrated. The third interface 1120 may include the summary data 1130 and the fourth interfacing object 1140. In response to the third input, the terminal 110 may receive the summary data 1130 from a language model server and display the summary data 1130 on the third interface 1120. The fourth interfacing object 1140 may be displayed via a button (e.g., “Go to Chat”). The screen 1103 may transition to the screen 1105 in response to receiving a selection input corresponding to the fourth interfacing object 1140 from the user. According to an embodiment, in response to receiving a swipe input on the third interface 1120, a third interface corresponding to a third interfacing object arranged next to the third interfacing object 1110 within the second element may be displayed.

On the screen 1105, a screen navigating to a chatroom in response to a selection input corresponding to the fourth interfacing object 1140 from the user is illustrated. The terminal 110 may navigate to a chatroom (e.g., “Group Chat 1”) including a plurality of unread instant messages and display a screen in response to the selection input corresponding to the fourth interfacing object 1140. In this case, the displayed chatroom screen may be displayed corresponding to the location of a first received message 1150 among the plurality of unread instant messages. In addition, when the chatroom is accessed, the plurality of unread instant messages within the chatroom may be marked as read.

FIG. 11B is a flowchart illustrating a method of generating summary data, according to an embodiment.

In response to a swipe input from a user on a third interface, the third interface may transition to a fourth interface for displaying a preview corresponding to a third interfacing object arranged after or before a selected third interfacing object among a plurality of third interfacing objects within a second element. According to an embodiment, the swipe input may be replaced with a selection input on the right area or the left area of a touch screen included in the terminal 110.

For example, referring to FIG. 11B, an interface 1120 and an interface 1160 may each correspond to one of the plurality of third interfacing objects arranged within the second element, and the interfaces may be sequentially transitioned and displayed in response to the swipe input. When the interface 1120 is a third interface displayed in response to receiving a third input, the interface 1120 may transition to the interface 1160 in response to receiving a swipe input corresponding to the right area of the interface 1120. In this case, the transitioned interface 1160 may correspond to the fourth interface. While in a state in which the interface 1160 is displayed, the interface 1160 may transition back to the interface 1120 in response to receiving a swipe selection input on the left area of the interface 1160. In addition, while an interface corresponding to the last-arranged third interfacing object among at least one third interfacing object included in the second element is being displayed, when a swipe input for displaying a next interface is received, display of the interfaces may be terminated. Alternatively, the interface may transition to an interface corresponding to the first-arranged third interfacing object within the second element.

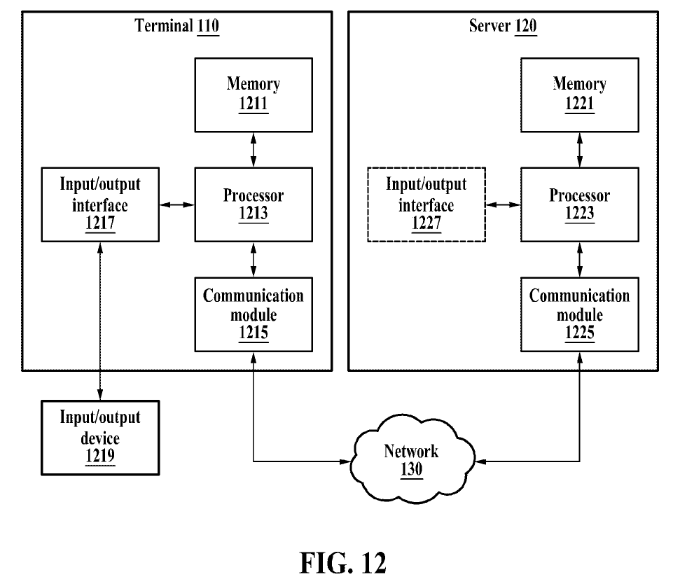

FIG. 12 is a diagram illustrating a hardware configuration of a system for providing an instant messaging service, according to an embodiment.

Referring to FIG. 12, the system (e.g., the system 100 of FIG. 1), according to an embodiment, may include the terminal 110 and the server 120 connected through the network 130.

The terminal 110 may be a mobile terminal implemented as a computer device. For example, the terminal 110 may communicate with the server 120 and/or other electronic devices through the network 130 by using a wired or wireless communication method.

The server 120 may be implemented as one or more computer devices providing commands, code, files, content, services, and the like by communicating with the terminal 110 and/or another server through the network 130. A communication method may not be limited and may include a communication method using a communication network (e.g., a mobile communication network, wired Internet, wireless Internet, and a broadcasting network) that may be included in the network 130 and a short-distance wireless communication method between devices. For example, the network 130 may include one or more networks among networks, such as a personal area network (PAN), a local area network (LAN), a campus area network (CAN), a metropolitan area network (MAN), a wide area network (WAN), a broadband network (BBN), the Internet, and the like.

According to an embodiment, the server 120 may provide a file for installing an app to the terminal 110 accessing the server 120 through the network 130. In this case, the terminal 110 may install the app (e.g., an instant messenger) by using the file provided by the server 120. In addition, by control of an OS and at least one program (e.g., a browser or an installed app) that are included by the terminal 110, the terminal 110 may access the server 120 and receive a service or content provided by the server 120. For example, when the terminal 110 transmits a service request message to the server 120 through the network 130 by control of the app, the server 120 may transmit code corresponding to the service request message to the terminal 110 and the terminal 110 may provide a user with content by composing and displaying a screen according to the code.

According to an embodiment, the terminal 110 and the server 120 may respectively include memories 1211 and 1221, processors 1213 and 1223, communication modules 1215 and 1225, and input/output interfaces 1217 and 1227.

The processors 1213 and 1223, according to an embodiment, may perform at least one of the operations described above with reference to FIGS. 1-11. For example, the processor 1213 may perform at least one operation performed in the instant messaging service installed on the terminal 110 described above with reference to FIGS. 1 and 11, and the processor 1223 may perform at least one operation associated with the instant messaging service described above with reference to FIGS. 1-11. The processors 1213 and 1223 may be configured to process commands of a computer program by performing basic arithmetic, logic, and an input/output operation. The commands may be provided to the processors 1213 and 1223 by the memories 1211 and 1221 or the communication modules 1215 and 1225.

The memories 1211 and 1221 may be a computer-readable storage medium, which may be volatile or non-volatile memory. According to an embodiment, the memories 1211 and 1221 may store information for executing the instant messenger described above with reference to FIGS. 1-11. For example, the memory 1221 may store the information of user accounts having subscribed to the instant messaging service and the information of chatrooms.

The memory 1211 may include code for the instant messenger that is installed to be driven in the terminal 110 by files provided by the server 120 through the network 130.

The memory 1221 may store a program implementing operations for the instant messaging service described above with reference to FIGS. 1-11.

The communication modules 1215 and 1225 may provide a function for the terminal 110 and the server 120 to communicate with each other through the network 130 and a function for the terminal 110 and the server 120 to communicate with another electronic device or another server through the network 130.

For example, a request generated by the processor 1213 of the terminal 110 according to program code on an instant messenger stored in a storage medium, such as the memory 1211, may be transmitted to the server 120 through the network 130 by control of the communication module 1215.

For example, control signals, commands, content, files, and the like provided by control of the processor 1223 of the server 120 may be received by the terminal 110 through the communication module 1215 of the terminal 110 after passing through the communication module 1225 and the network 130.

The input/output interfaces 1217 and 1227 may be an interface with an input/output device 1219. For example, an input device may include a device, such as a keyboard or a mouse, and an output device may include a device, such as a display for displaying a communication session of an app. In another example, the input/output interface 1217 may be an interface with a device having input and output functions, such as a touch screen. Specifically, for example, when the processor 1213 of the terminal 110 processes commands of a computer program loaded in the memory 1211, content or a service screen configured by using data provided by the server 120 may be displayed on a display through the input/output interface 1217. An input received from the user through the input/output device 1219 may be provided in a processable form in the processor 1213 of the terminal 110 through the input/output interface 1217.

According to an embodiment, the terminal 110 and the server 120 may include other components than the illustrated ones in FIG. 12. For example, the terminal 110 may be implemented to include at least a part of the input/output device 1219 described above or may further include other components, such as transceivers, global positioning system (GPS) modules, cameras, various types of sensors, databases, and the like.

The embodiments described herein may be implemented using a hardware component, a software component and/or a combination thereof. For example, the apparatus, the method, and the components described in the examples may be implemented using a general-purpose or special-purpose computer, such as a processor, a controller and an arithmetic logic unit (ALU), a digital signal processor (DSP), a microcomputer, a field programmable gate array (FPGA), a programmable logic unit (PLU), a microprocessor, or any other devices capable of responding to and executing instructions. A processing device may run an OS and a software app that runs on the OS. The processing device may also access, store, manipulate, process, and generate data in response to execution of software. For purpose of simplicity, the description of a processing device is used as singular; however, one skilled in the art will appreciate that a processing device may include a plurality of processing elements and/or a plurality of types of processing elements. For example, the processing device may include a plurality of processors, or a single processor and a single controller. In addition, different processing configurations are possible, such as parallel processors.

Software may include a computer program, a piece of code, an instruction, or one or more combinations thereof, to independently or collectively instruct or configure a processing device to operate as desired. Software and/or data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The method according to the above-described embodiments may be recorded in non-transitory computer-readable media including program instructions to implement various operations which may be performed by a computer. The non-transitory computer-readable storage media may also store, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable storage media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random-access memory (RAM), flash memory, and the like. Examples of program instructions include both machine code, such as code produced by a compiler, and files including higher level code that may be executed by the computer using an interpreter.

The hardware devices described above may be configured to act as one or more software modules in order to perform the operations of the embodiments described above, or vice versa.

In an embodiment, a terminal device may include a display, a communication interface, at least one processor, and a memory storing instructions executable by the at least one processor. The communication interface may be configured to communicate with one or more external devices or servers to transmit and receive data associated with an instant messaging service. The memory may store a plurality of instant messages associated with one or more chatrooms in which an account of a user participates. The at least one processor may execute instructions to obtain the plurality of instant messages from the memory, such that the plurality of instant messages corresponds to messages previously received and stored by the terminal device.

In an embodiment, the at least one processor may be configured to select, from the plurality of instant messages, a subset of instant messages based on a predefined condition. The predefined condition may include receipt time information associated with each instant message and content type information associated with each instant message. The receipt time information may correspond to a time at which each instant message was received or transmitted, and the content type information may correspond to a type of content included in each instant message, including, for example, text, image, video, link information, or file data. Based on the predefined condition, the at least one processor may filter the plurality of instant messages to identify the subset of instant messages for further processing.

In an embodiment, the at least one processor may generate preview data for each instant message in the subset of instant messages by transforming content of each instant message into a reduced data representation based on the content type. The reduced data representation may include, for example, a thumbnail image generated from image content, a representative frame or muted playback segment generated from video content, or metadata extracted from link information. The at least one processor may store the generated preview data in the memory, such that the preview data may be accessed for rendering without requiring retrieval or decoding of full message content.

In an embodiment, the at least one processor may control the display to render a user interface including a first region and a second region. The first region may include a plurality of elements corresponding to the one or more chatrooms, and each element may represent a respective chatroom. The second region may include a plurality of preview elements corresponding to the preview data generated for the subset of instant messages. Each preview element may display at least a portion of the preview data corresponding to a respective instant message. The first region and the second region may be arranged within the user interface such that both regions are concurrently visible or accessible to a user.

In an embodiment, the at least one processor may process input received via the display, such as touch input, gesture input, or other forms of user interaction. The at least one processor may scroll the first region in a first direction in response to a first input, and may scroll the second region in a second direction different from the first direction in response to a second input. For example, the first direction may correspond to a vertical direction and the second direction may correspond to a horizontal direction. By processing input in this manner, the terminal device may enable independent navigation of the first region and the second region.

In an embodiment, the at least one processor may receive a selection input corresponding to one of the preview elements displayed in the second region. In response to receiving the selection input, the at least one processor may determine a location of a corresponding instant message within a chatroom based on metadata associated with the corresponding instant message. The metadata may include, for example, message identifiers, timestamps, or positional information within a message sequence. Based on the determined location, the at least one processor may control the display to render the chatroom at the determined location, such that the corresponding instant message is presented to the user without requiring manual navigation through the chatroom.

In an embodiment, a computer-implemented method of operating a terminal device may include operations corresponding to those described above with respect to the terminal device. The method may include obtaining, by one or more processors of the terminal device, a plurality of instant messages associated with one or more chatrooms, selecting a subset of the plurality of instant messages based on a predefined condition including receipt time information and content type information, generating preview data for each instant message in the subset of instant messages by transforming content of each instant message into a reduced data representation, and storing the preview data in a memory of the terminal device. The method may further include controlling a display of the terminal device to render a user interface including a first region corresponding to chatrooms and a second region corresponding to preview data, processing input to scroll the respective regions in different directions, receiving a selection input corresponding to a preview element, and determining a location of a corresponding instant message within a chatroom based on metadata to render the chatroom at the determined location.

Additional embodiments and resulting improvements in processing and rendering operations are described below.

In some embodiments, the terminal device performs selective message processing by filtering a plurality of messages stored in memory based on one or more predefined conditions, including receipt time, message type, and visibility status. The filtering operation reduces the number of messages subject to subsequent processing, thereby limiting memory access operations and reducing computational load associated with processing large message datasets. The filtered messages may be stored in a separate data structure, such as a temporary buffer or indexed list, to enable efficient retrieval and further processing without requiring repeated access to the full set of messages maintained by the terminal or a remote server.

In some embodiments, preview data corresponding to the filtered messages is generated by transforming message content into reduced data representations suitable for rendering within a constrained display region. For example, image data may be converted into thumbnail representations, video data may be processed to extract representative frames or short playback segments, and link information may be parsed to obtain metadata such as title or image data. These transformations may be performed using a rendering pipeline that operates on message content stored in memory, and the resulting preview data may be cached locally to avoid repeated decoding or retrieval of full message content. By generating and storing reduced representations, the terminal device limits processing overhead and reduces latency associated with rendering message previews.

In some embodiments, the terminal device maintains a multi-region user interface in which a first region corresponding to chatroom elements and a second region corresponding to preview elements are independently scrollable along different axes. Input events received through an input interface, such as touch gestures, may be processed by an input handling module that determines a direction and magnitude of the input and applies the input to the appropriate region. This separation of interface regions enables the terminal device to update display content in one region without triggering re-rendering or data loading operations in the other region, thereby reducing graphical processing overhead and improving responsiveness of the user interface.

In some embodiments, navigation to message content is performed using a context-limited retrieval operation. In response to a user input selecting a preview element, the terminal device retrieves a subset of messages within a predefined temporal range relative to the selected message, rather than loading an entire message history associated with a chatroom. The subset of messages may be identified using metadata associated with each message, such as timestamps or message identifiers, and retrieved through a bounded query operation applied to locally stored data or a remote data source. This approach reduces the volume of data retrieved and processed, thereby decreasing network communication and memory usage while enabling contextual presentation of message content.

In some embodiments, the terminal device may generate summary data for a set of unread messages in response to a user input. The terminal device selectively transmits a subset of unread messages to a processing module, such as a local or remote language processing module, based on predefined criteria including message recency or quantity. By limiting the number of messages transmitted and deferring generation of summary data until receipt of the user input, the terminal device controls utilization of computational resources and reduces unnecessary processing operations. The generated summary data may be stored and rendered as part of the user interface, thereby providing access to aggregated message information without requiring loading and rendering of the full set of unread messages.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuitry are combined in a different manner, or replaced or supplemented by other components or their equivalents.

Therefore, other implementations, other examples, and equivalents to the claims are also within the scope of the following claims.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A terminal for performing an instant messaging service, the terminal comprising:
a display;
a communication interface;
a memory; and
at least one processor coupled to the memory,
wherein the memory stores instructions that, when executed individually or collectively by the at least one processor, cause the terminal to:
obtain, from among first instant messages loaded on the terminal and corresponding to one or more chatrooms in which an account of a user participates, second instant messages corresponding to a predefined condition;
generate a first element corresponding to the chatroom;
generate interfacing objects configured to display a preview of at least a portion of the second instant messages, based on content types corresponding to the second instant messages;
generate a second element including the interfacing objects, based on a first criterion according to a receipt time of each of the second instant messages and second criteria corresponding to the content types; and
display a list view including the first element and the second element.

2. The terminal of claim 1, wherein the at least one processor, cause the terminal to:
generate the list view by disposing the second element above the first element.

3. The terminal of claim 1, wherein the first element and the second element are scrollable in a first direction within the list view; and
the interfacing objects are scrollable in a second direction, which is different from the first direction, within the second element.

4. The terminal of claim 1, wherein the generating of the second element comprises:
sorting the second instant messages according to the first criterion;
sorting the second instant messages based on the content types and the second criteria corresponding to the content types; and
generating the second element in which the interfacing objects are arranged based on a sorting order of corresponding second instant messages.

5. The terminal of claim 1, wherein the second criteria corresponding to the content types comprise a criterion for differentiating sorting among second instant messages having a common attribute.

6. The terminal of claim 1, wherein the at least one processor, cause the terminal to:
receive, from the user, a first input corresponding to one of the interfacing objects; and
in response to receiving the first input, sort the interfacing objects on the second element wherein remaining interfacing objects are arranged with higher priority than the one interfacing object.

7. The terminal of claim 1, wherein the at least one processor, cause the terminal to:
receive, from the user, a first input corresponding to one of the interfacing objects; and
display a chatroom including a second instant message corresponding to the one interfacing object.

8. The terminal of claim 7, wherein the displaying of the chatroom comprises:
in response to receiving the first input, displaying a first interface including a preview of the corresponding second instant message and a second interfacing object for navigating to the chatroom; and
in response to receiving, from the user, a second input corresponding to the second interfacing object, displaying the chatroom.

9. The terminal of claim 8, wherein the at least one processor, cause the terminal to:
in response to receiving the first input, obtain, from among the first instant messages, at least one third instant message received within a predefined time range from a receipt time of the corresponding second instant message in the chatroom; and
display the at least one third instant message on the first interface.

10. The terminal of claim 7, wherein the displaying of the chatroom comprises:
determining, based on log data of the corresponding second instant message, a position of the corresponding second instant message within the chatroom; and
displaying the chatroom based on the position wherein the corresponding second instant message is displayed.

11. The terminal of claim 8, wherein the first interface is displayed on the terminal for a third predefined time; and
in response to expiration of the third predefined time, the first interface is transitioned to a second interface configured to display a preview corresponding to an interfacing object arranged after the selected interfacing object within the second element.

12. The terminal of claim 8, wherein in response to a swipe input from the user, the first interface is transitioned to a second interface configured to display a preview corresponding to an interfacing object arranged before or after the selected interfacing object within the second element.

13. The terminal of claim 1, wherein each of the interfacing objects is configured to display a combination of at least one of information of a chatroom including a corresponding second instant message, sender information of the corresponding second instant message, preview data based on the content types, and receipt time information of the corresponding second instant message.

14. The terminal of claim 1, wherein the at least one processor, cause the terminal to:
obtain, from among the first instant messages, a plurality of unread instant messages corresponding to the one or more chatrooms, and
the generating of the interfacing objects comprises:
generating, for a chatroom including at least a portion of the plurality of unread instant messages, at least one third interfacing object configured to display summary data of at least a portion of the plurality of unread instant messages.

15. The terminal of claim 14, wherein the at least one processor, cause the terminal to:
receive, from the user, a third input corresponding to one of the at least one third interfacing object included in the second element;
in response to the third input, obtain summary data corresponding to at least a portion of the plurality of unread instant messages; and
display a third interface configured to display the summary data.

16. The terminal of claim 15, wherein in response to an input from the user, the third interface is transitioned to a fourth interface configured to display a preview corresponding to a third interfacing object arranged before or after the one of the at least one third interfacing object within the second element.

17. The terminal of claim 1, wherein the obtaining of the second instant messages comprises:
obtaining the second instant messages by excluding, from among the first instant messages, an instant message corresponding to at least one of an instant message that is deleted or an instant message included in a hidden chatroom.

18. The terminal of claim 1, wherein the obtaining of the second instant messages comprises:
obtaining the second instant messages in response to at least one of:
an access to a first tab configured to display the list view within the instant messaging service;
the access to the first tab according to a transition to a foreground during background execution of the instant messaging service;
a transition to the first tab during access to a second tab within the instant messaging service;
the access to the first tab according to receiving an input of a back button while a second screen, which is different from a first screen displaying the first tab, is displayed; and
not receiving a second new instant message within a predefined time after receiving a first new instant message while the first screen is displayed.

19. A non-transitory computer-readable storage medium storing instructions that, when executed by a processor, cause the processor to perform the method of claim 1.

20. A method of operating a terminal using an instant messaging service, the method comprising:
obtaining, from among first instant messages loaded on the terminal and corresponding to one or more chatrooms in which an account of a user participates, second instant messages corresponding to a predefined condition;
generating a first element corresponding to the one or more chatrooms;
generating interfacing objects configured to display a preview of at least a portion of the second instant messages, based on content types corresponding to the second instant messages;
generating a second element including the interfacing objects, based on a first criterion according to a receipt time of each of the second instant messages and second criteria corresponding to the content types; and
displaying a list view including the first element and the second element.

21. A terminal, comprising:
a display;
a communication interface;
at least one processor; and
a memory storing instructions that, when executed by the at least one processor, cause the terminal device to:
obtain a plurality of instant messages associated with one or more chatrooms and stored in the memory;
select, from the plurality of instant messages, a subset of instant messages based on a predefined condition including (i) receipt time information and (ii) content type information associated with the instant messages;
generate preview data for each of the subset of instant messages by transforming content of each instant message into a reduced data representation based on the content type;
store the preview data in the memory;
control the display to render a user interface including:
a first region including a plurality of elements corresponding to the one or more chatrooms, and
a second region including a plurality of preview elements corresponding to the preview data.
